(19) United States
(12) Patent Application Publication
(10) Pub. No.: US 2026/0220272 A1
(43) Pub. Date: Jul. 30, 2026

(54) METHODS AND APPARATUS FOR FIRMWARE-ANCHORED PAYLOAD

(71) Applicant: Intel Corporation, Santa Clara, CA (US)

(72) Inventor: Yaaqov GUETTA, Netanya (IL)

(21) Appl. No.: 19/574,510

(22) Filed: Mar. 23, 2026

(51) Int. Cl. G06F 21/57; G06F 21/60; G06F 21/64

(52) U.S. Cl. CPC G06F 21/575; G06F 21/602; G06F 21/64

(57) ABSTRACT

A computing system includes: a non-volatile storage configured to store a payload and a digital signature of the payload; a protected non-volatile storage; a trusted storage configured to store a cryptographic key; and a processor configured to: execute a firmware during a boot phase, wherein the firmware is configured to cause the processor to: verify the digital signature using the cryptographic key stored in the trusted storage of the computing system; compute a first cryptographic hash value of the payload upon successful verification of the digital signature; and store the first cryptographic hash value as an anchor value in the protected non-volatile storage, wherein the processor is further configured to validate, in response to a received access request to the payload, the payload by comparing a second cryptographic hash value, computed from the payload, with the first cryptographic hash value.

### BACKGROUND

Modern computing platforms require extensive platform-specific content consumed by firmware subsystems, platform services, and runtime software components. Such content may include, by way of non-limiting example, wireless regulatory parameters governing transmit power and channel restrictions for wireless interfaces, thermal management profiles specifying fan speed curves and power throttling thresholds, power delivery settings for negotiation protocols such as USB Power Delivery, security policy manifests defining platform security posture, display or sensor calibration tables characterizing panel gamma responses or inertial measurement unit bias coefficients, and executable firmware modules such as UEFI drivers or UEFI applications intended to be loaded and executed during the boot phase.

Platforms have conventionally stored such content in firmware flash memory, typically serial peripheral interface (SPI) flash devices providing between 32 and 64 megabytes of capacity. SPI flash can be integrated into the platform hardware security chain and protected by hardware write-protection mechanisms enforced by the firmware. Firmware code and embedded cryptographic key material stored in SPI flash together may constitute the root of trust relied upon by the platform during the boot phase.

### BRIEF DESCRIPTION OF FIGURES

In the drawings, like reference characters generally refer to the same parts throughout the different views. The drawings are not necessarily to scale, emphasis instead generally being placed upon illustrating the principles of the disclosure. In the following description, various aspects of the disclosure are described with reference to the following drawings, in which:

FIG. 1 illustrates a block diagram of an example computing system

FIG. 2 illustrates a block diagram of an example computing system according to various aspects described herein;

FIGS. 3A and 3B illustrate an example sequence flow for initial provisioning of a computing system;

FIG. 4 illustrates an example sequence flow in accordance with various aspects described herein;

FIG. 5A and FIG. 5B illustrate an example sequence flow for a reboot-based update;

FIG. 6A and FIG. 6B illustrate an example sequence flow including a live update of the payload;

FIG. 7 illustrates an example sequence flow for boot-time validation and execution of an executable firmware module;

FIG. 8 shows an example of a method.

### DESCRIPTION

The present disclosure relates to computing systems and, more particularly, to methods, devices, and systems for verifying the integrity of data and executable modules stored on non-volatile storage during the boot and runtime phases of a computing platform.

Storing platform-specific content in SPI flash creates significant technical and operational constraints. SPI flash capacity is limited and its cost per byte is substantially higher than that of disk-based storage. As platform-specific content grows to encompass comprehensive regulatory databases, possibly spanning multiple jurisdictions, large calibration tables, and executable firmware modules measuring several megabytes, the aggregate storage cost burden at manufacturing scale becomes significant. Flash capacity consumed by platform-specific content directly competes with firmware code and other platform data for the fixed storage budget available in a given SPI flash device. Further, any modification to SPI flash-resident content requires firmware reflashing involving assembly of a complete firmware image, device-level validation, and physical programming of the flash device. Firmware reflashing carries an inherent risk of unrecoverable device failure if the programming process is interrupted or if the assembled image is malformed, a failure mode commonly referred to as device bricking. Reflashing further entails extensive pre-deployment testing and validation cycles that extend the interval between field incidents and the availability of corrective content updates by weeks or months.

Moreover, deploying updates to SPI flash-resident content requires specialized tooling, such as UEFI firmware capsule update frameworks, and can mandate staged rollout procedures coordinated with firmware release cycles and independent BIOS vendor workflows. This operational overhead makes frequent or rapid updates impractical. Original equipment manufacturers assembling computing platforms from third-party silicon and firmware components are particularly affected. Distributing a regulatory parameter update, for example, a correction to Wi-Fi channel restrictions or Bluetooth transmit power limits mandated by regulatory authority revision in a specific geographic market, requires the original equipment manufacturer to integrate the parameter change into a full firmware image, coordinate the update with independent BIOS vendors, conduct platform-level certification testing, and distribute the result through firmware update channels to end users. In practice, original equipment manufacturers operating large platform families, such as commercial laptop product lines spanning many SKUs, have declined to deploy such updates even when technically warranted, because the operational and certification burden of a firmware reflash cycle is disproportionate relative to the scope of the content change. This creates a structural gap between the frequency at which platform-specific content must change in the field and the cadence at which SPI flash updates can practically be released.

In an alternative approach, platform-specific content is stored as files on disk-based partitions, such as an EFI System Partition, which is accessible to firmware during the boot phase and to the operating system during the runtime phase. Disk-based storage is substantially less expensive per byte than SPI flash and can be updated by operating system processes using standard file system operations, without any modification to firmware. However, disk-based storage is mutable by the operating system, by system administrators, and by software executing with sufficient access privileges, including malicious software; disk-based storage therefore cannot be treated as trusted without additional integrity controls. Storing platform-specific content as unprotected files on disk provides no cryptographic integrity guarantee and is not viable in production deployments that require tamper resistance. Existing secure-boot architectures address related problems but exhibit critical limitations when applied to the present context. Some verified boot architectures (e.g. ChromeOS Verified Boot) perform firmware-level hash verification of kernel partition content against a hash-tree root established at factory provisioning time, and they do not support OS-scriptable updates to arbitrary mutable platform content and provide no authenticated anchor mechanism for platform-specific payloads that must be updated after manufacture. Some boot architectures (e.g. Android Verified Boot) use a bootloader to verify a vbmeta partition digest but require a special device unlock mode for content updates and provide no continuous runtime revalidation after the boot phase concludes.

In some other architectures, a hardware root of trust is provided, which records a measured-boot attestation log for firmware and operating system components, but these architectures may target attestation of firmware and operating system integrity rather than mutable external platform-specific payloads stored outside firmware flash. They may not publish a firmware-controlled integrity anchor for content held on disk-based storage that must be validated by runtime software components prior to use.

None of the foregoing approaches provides the combination of: a protected variable-based anchor storage mechanism in which a cryptographic hash value of a cryptographically verified payload is written by firmware to authenticated non-volatile storage and is subsequently readable during both the boot phase and the runtime phase without distributing asymmetric key material to runtime software; a dual-phase verification architecture in which asymmetric digital signature verification is performed once during the boot phase and lightweight hash-based validation is performed at each subsequent consumption event; OS-scriptable update of both the external payload and the cryptographic anchor without firmware reflashing; and lifecycle fields enabling anti-rollback enforcement and cryptographic algorithm migration.

The term "payload" as used herein may refer to data and/or an executable module stored in non-volatile storage outside firmware flash, which may particularly include platform-specific data, including one of or a combination of: configuration tables, regulatory parameter sets, thermal or calibration data, security policy content, and executable firmware modules. The term "digital signature" as used herein may refer to a cryptographic artefact produced by applying an asymmetric signing operation with a private key over a defined byte domain of a payload, enabling a recipient holding the corresponding public key to confirm that the payload was produced by an authorized party and has not been subsequently modified.

The term "cryptographic key" as used herein may refer to key material used by the firmware to perform cryptographic operations. In some aspects, the cryptographic key used for signature verification is an asymmetric public key held in trusted storage. The term "cryptographic hash value" may refer to a fixed-length digest produced by applying a cryptographic hash function, such as SHA-256, producing a 32-byte output, or SHA-384, producing a 48-byte output, to a defined byte domain of a payload.

The term "verification", as used herein, of a digital signature may refer to the asymmetric operation performed by firmware (or by an authorized update process) to confirm, using the cryptographic key, that a given digital signature was computed over an intact payload using the corresponding private key. The term "validation", as used herein, of a payload denotes the operation of computing a fresh cryptographic hash value over the payload and comparing the result, in constant time, with a previously stored cryptographic hash value, noting that validation does not require access to an asymmetric private key (asymmetric key material). An "anchor value", as described herein, is a value stored in protected non-volatile storage representing at least the cryptographic hash value of a payload that has been previously verified by firmware (e.g., verified during anchor establishment, for example by firmware during the boot phase or by an authorized update process during an authenticated runtime update), optionally together with associated metadata such as a version identifier, a hash algorithm identifier, a key identifier, a location identifier, and a timestamp.

The term, “non-volatile storage", as used herein, denotes storage configured to retain a payload and an associated digital signature in the absence of power supply, accessible to the operating system and to runtime software components during the runtime phase and accessible to firmware during the boot phase. Non-volatile storage of this type is mutable by the operating system, by system administrators, and by software executing with sufficient privileges, and is therefore treated as untrusted in the absence of independent integrity controls. The term, “protected non-volatile storage", as used herein, may refer to non-volatile storage configured to store the anchor value and protected such that write access is conditioned on a cryptographic authorization artefact supplied with the write operation. For example, a specific implementation may be UEFI authenticated variable storage supporting the EFI_VARIABLE_TIME_BASED_AUTHENTICATED_WRITE_ACCESS attribute, which accepts write operations only when accompanied by a valid signed authentication descriptor.

The term "trusted storage", as used herein, may refer to storage holding the cryptographic key used for digital signature verification and, optionally, the firmware itself. Trusted storage may be protected by platform hardware security mechanisms and form the root of trust. The term "authenticated write access", as used herein, may refer to a write access mechanism that requires and verifies a cryptographic authorization artefact accompanying each write operation, enforced by firmware or platform hardware. The "boot phase" may refer to the phase during which the processor executes firmware prior to loading the operating system. The "runtime phase" is the phase during which the operating system and runtime software components execute after the boot phase. The term “access request", as used herein, may refer to a request issued by a software component or by the firmware to read and use a payload from non-volatile storage.

In accordance with various aspects described herein, a computing system may be configured, such that its firmware can perform a single cryptographic verification of a digital signature of a payload stored in non-volatile storage during the boot phase. Upon successful verification during the boot phase, the computing system may compute a first cryptographic hash value of the payload and can store that value, together with optional associated metadata, as an anchor value in protected non-volatile storage. In some runtime update embodiments, an authorized operating system process may verify a replacement digital signature of a replacement payload before submitting an authenticated update request that refreshes the anchor value during the runtime phase without requiring a reboot. Subsequent consumers of the payload can validate payload integrity by computing a fresh cryptographic hash value over the payload held in the non-volatile storage and comparing the result against the anchor value stored in the protected non-volatile storage, without requiring access to an asymmetric private key (asymmetric key material) or repetition of the computationally expensive asymmetric verification operation.

Correspondingly, the impracticality of distributing asymmetric key material to runtime software components and the cost of performing repeated asymmetric verification operations at every consumption event can be addressed, considering the described architecture can separate the trust-establishment operation, performed once by firmware (e.g., performed when the anchor is created or refreshed by firmware during boot or by an authorized update process during a runtime authenticated update), from the trust-validation operation, performed at each consumption event by any authorized consumer.

In various aspects, the anchor value stored in the protected non-volatile storage can be readable by firmware during the boot phase and by runtime software components during the runtime phase, possibly using the same protected non-volatile storage as a phase-transcending integrity bridge. The protected non-volatile storage may be configured such that write access is conditioned on a cryptographic authorization artefact, which would make the anchor value tamper-resistant against software executing at operating system privilege, including administrative users and malicious software. Correspondingly, a single protected store can be provided, which holds a firmware-established integrity reference that was simultaneously accessible during the boot phase and the runtime phase and resistant to unauthorized modification from the operating system level.

In some aspects, during the boot phase, the firmware can determine whether an anchor value is already present in the protected non-volatile storage before performing digital signature verification. When the firmware detects that a computed cryptographic hash value of the payload does not match the first cryptographic hash value recorded in an existing anchor value, the firmware can re-perform digital signature verification of the payload. If the digital signature is valid, the firmware may compute an updated cryptographic hash value and replace the first cryptographic hash value stored as the anchor value with the updated value. If the digital signature is not valid, the firmware can delete the anchor value from the protected non-volatile storage, preventing any consumer from treating the modified payload as trusted. Correspondingly, in case of a stored anchor value becoming stale when the payload is replaced or modified, described conditional re-verification mechanism can ensure that the anchor value in the protected non-volatile storage always corresponds to a payload whose digital signature has been successfully verified by firmware.

Aspects described herein may allow a payload stored in non-volatile storage to be updated by replacing the payload and its associated digital signature as files in the non-volatile storage, without reflashing firmware or modifying trusted storage, and without any specialized firmware update tooling. Following such a file replacement, the firmware can detect the mismatch between the updated payload and the existing anchor value at the next boot phase and re-perform verification and anchor value update in accordance with the mechanism described above. Additionally, or alternatively, the anchor value in the protected non-volatile storage may itself be updated during the runtime phase in response to an authenticated update request, enabling the anchor value to be refreshed without requiring a reboot cycle. Correspondingly, operational cost and bricking risk associated with firmware reflashing as a precondition for deploying updates to platform-specific content can be addressed.

In various aspects, the same anchor value mechanism can apply uniformly to payloads including platform configuration data, such as wireless regulatory parameters, thermal management profiles, or calibration tables, and to payloads including executable firmware modules intended to be executed during the boot phase. When a payload includes an executable firmware module, the firmware, having validated the payload against the anchor value, can load and execute the module during the boot phase. When a payload includes configuration data, runtime software components can validate the payload against the anchor value prior to applying the configuration data.

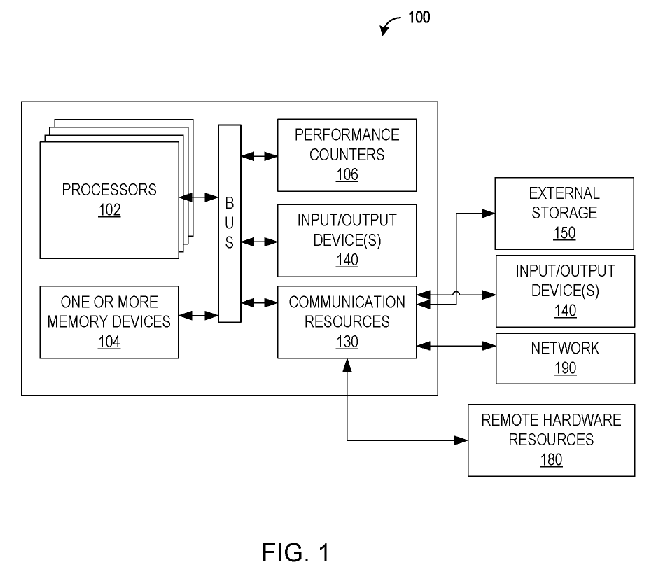

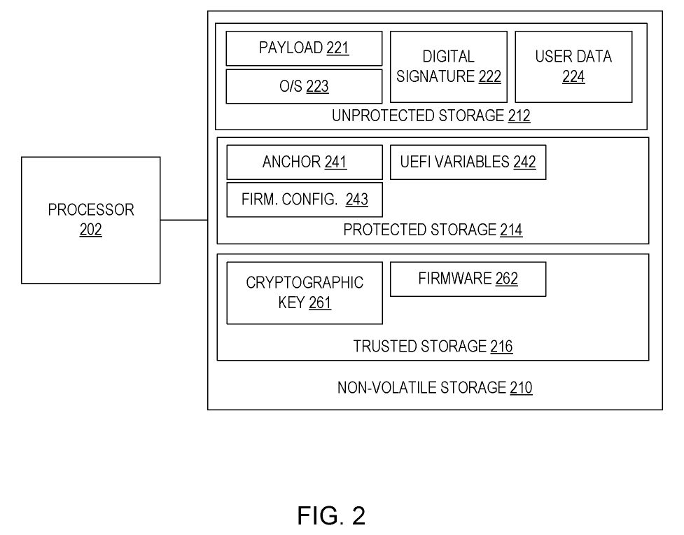

The following description provides detailed examples of computing systems and methods for verifying integrity of data stored on non-volatile storage. The computing system described with reference to FIG. 1 may be a general-purpose computing platform in which the aspects described herein may be implemented. The computing system described with reference to FIG. 2 may be an embodiment of the computing system in accordance with various aspects of this disclosure. For example, the non-volatile storage of the computing system may be partitioned into distinct trust domains, and in which a processor may execute firmware during a boot phase to establish a cryptographic anchor value that is subsequently used to validate a payload stored on an untrusted portion of the non-volatile storage.

A computing system as described herein may include a processor, a non-volatile storage configured to store a payload and a digital signature of the payload, a protected non-volatile storage configured to store an anchor value, and a trusted storage configured to store a cryptographic key. During a boot phase, firmware executed by the processor may be configured to verify the digital signature of the payload using the cryptographic key, compute a cryptographic hash value of the payload upon successful verification, and store the cryptographic hash value as the anchor value in the protected non-volatile storage. The anchor value may then serve as a reference for subsequent validation of the payload by comparing a freshly computed hash with the stored anchor value.

The computing system may be any of the computing platforms described with reference to FIG. 1. In particular, the processors 102 of FIG. 1 correspond to the processor that executes firmware during the boot phase. The one or more memory devices 104 and/or the external storage 150 of FIG. 1 may include the non-volatile storage, the protected non-volatile storage, and the trusted storage described in further detail with reference to FIG. 2. The communication resources 130 and input/output devices 140 of FIG. 1 may provide interfaces through which an operating system process deploys replacement payloads to the non-volatile storage during a runtime phase.

FIG. 1 illustrates a block diagram of an example computing system 100 in accordance with various aspects described herein. The computing system 100 typically includes a system of interconnected hardware and software resources configured to execute instructions, process data, and manage the allocation of computational capabilities. The computing system 100 may be a server, a workstation, a cluster of servers, a data center, or a cloud computing infrastructure. External storage 150, network 190, external input and output devices 140, and remote hardware resources 180 connect to the hardware resources via the communication resources 130 and input and output devices 140.

The computing system 100 generally includes one or more processors 102, one or more memory devices 104, a bus, communication resources 130, and one or more input/output devices 140. The processors 102 represent the computational core of the computing system 100 and each processor among the processors 102 integrates a cache hierarchy and a memory controller interface through which the processor 102 initiates memory transactions directed to the one or more memory devices 104.

The processors 102 may include one or more physical processing units. Each processing unit among the processors 102 may constitute a central processing unit, a microprocessor, a digital signal processor, or a graphics processing unit configured to perform general-purpose computing tasks. The processors 102 may include, for example, one or a combination of: a central processing unit (CPU), a reduced instruction set computing (RISC) processor, a complex instruction set computing (CISC) processor, a graphics processing unit (GPU), a DSP, an ASIC, an FPGA, a microprocessor or controller, a multi-core processor, a multithreaded processor, an ultra-low voltage processor, an embedded processor, an xPU, a data processing unit (DPU), an Infrastructure Processing Unit (IPU), a network processing unit (NPU), another processor (including any of those discussed herein), and/or any suitable combination thereof. Each processor among the processors 102 communicates with the one or more memory devices 104 through a memory controller that manages command scheduling, address mapping, rank selection, refresh management, and coordination of data transfers, incorporating timing control logic that enforces the temporal constraints imposed by the memory interface specification.

In some examples, the one or more processors 102 may execute instructions (e.g., non-transitory computer-readable instructions). Instructions may include software, program code, application(s), applet(s), an app(s), firmware, microcode, machine code, and/or other executable code for causing at least any one of the processors 102 to perform a method. The instructions may reside, completely or partially, within at least one of the processors 102 (e.g., within the processor's cache memory), the memory devices 104, or any suitable combination thereof. Furthermore, any portion of the instructions may be transferred to the computing system 100 from any combination of the input and/or output devices 140 or the external storage 150.

The one or more memory devices 104 provide the main storage for data and instructions that are actively used by the processors 102. The one or more memory devices 104 may include volatile memory technologies, such as dynamic random access memory, synchronous dynamic random access memory, or static random access memory. In high-performance configurations, the one or more memory devices 104 may include high bandwidth memory or double data rate synchronous dynamic random access memory. The one or more memory devices 104 may include non-volatile storages as described herein.

As examples, the memory devices 104 can be or can include random access memory (RAM), static RAM (SRAM), dynamic RAM (DRAM), synchronous DRAM (SDRAM), magnetoresistive RAM (MRAM), conductive bridge Random Access Memory (CB-RAM), spin transfer torque (STT)-MRAM, phase change RAM (PRAM), core memory, dual inline memory modules (DIMMs), microDIMMs, MiniDIMMs, block addressable memory device(s) (e.g., those based on NAND or NOR technologies (e.g., single-level cell (SLC), multi-level cell (MLC), quad-level cell (QLC), tri-level cell (TLC), or some other NAND), read-only memory (ROM), programmable ROM (PROM), erasable PROM (EPROM), electrically EPROM (EEPROM), flash memory, non-volatile RAM (NVRAM), solid-state storage, magnetic disk storage mediums, optical storage mediums, memory devices that use chalcogenide glass, multi-threshold level NAND flash memory, NOR flash memory, single or multi-level phase change memory (PCM) and/or phase change memory with a switch (PCMS), NVM devices that use chalcogenide phase change material (e.g., chalcogenide glass), a resistive memory, nanowire memory, ferroelectric transistor random access memory (FeTRAM), anti-ferroelectric memory, magnetoresistive random access memory (MRAM) memory that incorporates memristor technology, phase change RAM (PRAM), resistive memory including the metal oxide base, the oxygen vacancy base and the conductive bridge random access memory (CB-RAM), or spin transfer torque (STT)-MRAM, a spintronic magnetic junction memory based device, a magnetic tunneling junction (MTJ) based device, a domain wall (DW) and spin orbit transfer (SOT) based device, a thyristor based memory device, and/or a combination of any of the aforementioned memory devices, and/or other memory. The processors 102 and the one or more memory devices 104 communicate via a bus or an interconnect system.

The communication resources 130 enable the computing system 100 to exchange data with external entities. The communication resources 130 may include one or more network interface controllers, host bus adapters, or input/output fabric interfaces. The network interface controllers may support various communication standards, such as Ethernet, InfiniBand, or Fibre Channel. The communication resources 130 manage the physical and data link layers of the communication protocols, handling the transmission and reception of data packets. The communication resources 130 connect the computing system 100 to a network 190. The network 190 may be a local area network, a wide area network, the internet, or a dedicated storage area network. Through the network 190, the computing system 100 may access remote hardware resources 180 and external storage 150. For example, the communication resources 130 may include wired communication components, cellular communication components, Wi-Fi components, and other communication components

The input/output devices 140 associated with the computing system 100 represent local peripheral interfaces and devices. These may include storage controllers, such as redundant array of independent disks controllers, universal serial bus controllers, and interfaces for human interaction devices like keyboards and monitors if the system is configured for direct user interaction. The input/output devices 140 may also include hardware accelerators, such as field-programmable gate arrays or application-specific integrated circuits, installed to offload specific processing tasks from the processors 102. The bus facilitates the communication between the processors 102 and the input/output devices 140, often utilizing standards like peripheral component interconnect express. FIG. 11 also illustrates input/output devices 140 external to the computing system 100, which may represent peripherals connected via the communication resources 130 or the network 190, providing flexibility in system configuration.

The external storage 150 represents persistent data storage repositories located outside the immediate physical chassis of the computing system 100. The external storage 150 may include storage area networks, network-attached storage systems, or cloud-based storage services. The external storage 150 may store application data and operating system files that are loaded into the one or more memory devices 104 during operation. The connection to the external storage 150 allows for centralized data management and facilitates features such as high availability, where a workload can be restarted on different hardware resources if the primary hardware fails. Access to the external storage 150 is mediated by the communication resources 130 and the protocols of the network 190, such as internet small computer systems interface or non-volatile memory express over fabrics.

The remote hardware resources 180 generally represent other computing nodes or clusters available via the network 190. In a distributed computing system 100, the computing system 100 may function as one physical node in a larger cluster, with the remote hardware resources 180 constituting the other physical nodes. The remote hardware resources 180 may possess similar or different configurations compared to the computing system 100. The ability to communicate with the remote hardware resources 180 enables distributed processing, where a single large task is decomposed into smaller sub-tasks executed in parallel across multiple machines.

FIG. 2 illustrates a block diagram of an example computing system according various aspects described herein. The computing system of FIG. 2 includes a processor 202 and a non-volatile storage 210. The non-volatile storage 210 may include three distinct storage regions differentiated by their trust properties. The non-volatile storage 210 may include an unprotected storage 212, a protected storage 214, and a trusted storage 216. The processor 202 is coupled to the non-volatile storage 210 and is configured to access each of the three storage regions during different operational phases. The unprotected storage 212 corresponds to a non-volatile storage configured to store a payload and a digital signature of the payload. The protected storage 214 corresponds to a protected non-volatile storage configured to store the anchor value. The trusted storage 216 corresponds to a trusted storage configured to store a cryptographic key.

In some examples, the three storage regions described here may be physically distinct storage devices or may be logically distinct regions of one or more physical storage media. For example, the trusted storage 216 may be a SPI flash device, the protected storage 214 may be an NVRAM region of the same or a different flash device, and the unprotected storage 212 may be a partition on a disk drive or solid-state storage device.

The unprotected storage 212 stores a payload 221 and a digital signature 222 of the payload 221. The unprotected storage 212 may further store an operating system 223 and user data 224. The payload 221 may include platform-specific data intended for consumption by firmware or software components of the computing system. For example, the payload 221 may include one or a combination of: wireless regulatory parameters, thermal management profiles, power delivery settings, security policy manifests, display calibration tables, sensor calibration tables, and/or executable firmware modules such as UEFI driver images.

The digital signature 222 may be a cryptographic value computed over the payload 221 using a private key held by an entity external to the computing system, such as an original equipment manufacturer (OEM). The digital signature 222 can enable the computing system to authenticate the origin and integrity of the payload 221 by verifying the digital signature 222 against a corresponding public key. The unprotected storage 212 is accessible to the firmware during a boot phase and is accessible to the operating system 223 and runtime software components during a runtime phase. The unprotected storage 212 is considered untrusted because the operating system 223, administrative tools, or malicious software may modify, replace, or delete the payload 221 and the digital signature 222 stored thereon.

The digital signature 222 may be associated with the payload 221 such that the digital signature 222 covers a defined byte range of the payload 221. For example, the digital signature 222 may be appended to the payload 221 as a signature footer within a file stored on the unprotected storage 212, or the digital signature 222 may be stored as a separate file adjacent to the payload 221. The digital signature 222 may be computed by the OEM or another authorized signing entity using an asymmetric cryptographic algorithm such as RSA (Rivest-Shamir-Adleman) with a key length of at least 2048 bits, ECDSA (Elliptic Curve Digital Signature Algorithm) with a curve such as P-256 or P-384, or EdDSA (Edwards-curve Digital Signature Algorithm). The signing entity holds the private key and does not distribute the private key to the computing system. The computing system can hold only the corresponding public key, which is sufficient to verify the digital signature 222 but not to generate new signatures. The digital signature 222 can thereby provide authentication of the payload 221 without requiring the computing system to possess the signing capability.

The trusted storage 216 stores a cryptographic key 261 and it may store the firmware 262. The cryptographic key 261 may be the public key corresponding to the private key used by the OEM or signing entity to generate the digital signature 222. The cryptographic key 261 may be embedded in the trusted storage 216 during manufacturing or during a controlled provisioning process and may be protected against modification by hardware write-protection mechanisms of the trusted storage 216. The trusted storage 216 may include firmware storage such as a SPI flash memory device that is write-protected by hardware straps, lock registers, or protected range registers of a chipset. The firmware 262 may be the boot firmware of the computing system, which may be the software (e.g., code) that the processor 202 executes during the boot phase before the operating system 223 assumes control. The firmware 262 may include the verification logic, hash computation routines, and policy enforcement routines that implement the integrity verification described herein. The firmware 262 may read the cryptographic key 261 from the trusted storage 216 and use the cryptographic key 261 to verify the digital signature 222. Because both the firmware 262 and the cryptographic key 261 reside in the trusted storage 216, the root of trust for the verification process can be anchored in hardware-protected storage that is not modifiable by the operating system 223 or by runtime software.

In an example, the trusted storage 216 may firmware storage configured to store the firmware 262 and, in some embodiments, the cryptographic key 261. In some embodiments, the trusted storage 216 may further include at least one of a trusted platform module (TPM) or a secure element configured to store the cryptographic key 261 or to perform cryptographic operations used by the firmware 262. When the trusted storage 216 includes firmware storage, the trusted storage 216 may be a SPI flash device protected by a chipset-enforced write-protection mechanism such as a BIOS write-enable bit, a protected range register, or a SPI flash lock. When the trusted storage 216 includes a trusted platform module, the TPM can provide a dedicated, tamper-resistant hardware component conforming to Trusted Computing Group (TCG) specifications, offering secure key storage, platform configuration registers, and cryptographic operations isolated from the processor 202 and the operating system 223. The TPM may be a discrete TPM chip, a firmware-based TPM (fTPM) executing within a trusted execution environment of the processor 202, or an integrated TPM module within a chipset. When the trusted storage 216 includes a secure element, the secure element may be a dedicated tamper-resistant hardware module providing key storage and cryptographic operations, such as a hardware security module (HSM) or a smart card controller integrated into the computing platform. Each of the firmware storage, the TPM, and the secure element can provide a hardware-backed root of trust that protects the cryptographic key 261 against extraction or modification by software running on the processor 202 during the runtime phase.

The protected storage 214 stores an anchor 241, and it may further store UEFI variables 242, and firmware configuration data 243. The anchor 241 corresponds to the anchor value, which may include cryptographic hash value of the payload 221 stored in the protected storage 214 after successful verification of the digital signature 222 by the firmware 262. The UEFI variables 242 are authenticated variables maintained by the firmware 262 for storing configuration and state information. The firmware configuration data 243 may represent boot configuration data or supplementary firmware data that the firmware 262 maintains in the protected storage 214.

In an example, the protected storage 214 can be implemented as a non-volatile random access memory (NVRAM) region, which may physically reside on the same flash device as the trusted storage 216 or on a separate non-volatile storage medium. The protected storage 214 may be distinguished from the trusted storage 216 in that the protected storage 214 is writable during operation, but only through an authenticated write access mechanism. The protected storage 214 may be distinguished from the unprotected storage 212 in that the unprotected storage 212 is freely writable by the operating system 223, whereas the protected storage 214 rejects write operations that do not carry valid cryptographic authorization.

The non-volatile storage 210 may include three distinct trust domains. The trusted storage 216 may constitute the root of trust of the computing system, such that the cryptographic key 261 and the firmware 262 stored in the trusted storage 216 may be protected by hardware-enforced write-protection mechanisms and are not modifiable by the operating system 223 or by any software executing during the runtime phase. The protected storage 214, corresponding to the protected non-volatile storage, may constitute the anchor value store, such that the anchor value 241 stored in the protected storage 214 is protected by the authenticated write access mechanism and is readable during both the boot phase and the runtime phase. The unprotected storage 212, corresponding to the non-volatile storage, may constitute the untrusted bulk storage, such that the payload 221 and the digital signature 222 stored in the unprotected storage 212 are freely readable and writable by the operating system 223 and by any process with sufficient access privileges. Integrity enforcement may be concentrated in the trusted storage 216 and the protected storage 214; the unprotected storage 212 holds the payload 221 whose integrity the computing system enforces through the anchor value 241 rather than through access control on the unprotected storage 212 itself.

In an example, the protected storage 214 may be protected by an authenticated write access mechanism, and the protected storage 214 can be further configured to store authenticated variables for the firmware 262, such as the UEFI variables 242. The authenticated write access mechanism requires that any write operation to the protected storage 214 be accompanied by a cryptographic authorization, such as a signed variable update payload. In a UEFI embodiment, the anchor 241 may be stored as a UEFI authenticated variable having the EFI_VARIABLE_TIME_BASED_AUTHENTICATED_WRITE_ACCESS attribute. The firmware 262 may enforce the authenticated write access mechanism. For example, when a write request is received, whether from the firmware 262 during the boot phase or from the operating system 223 during the runtime phase, the firmware 262 may validate the accompanying cryptographic authorization before committing the write to the protected storage 214. If the cryptographic authorization is absent or invalid, the firmware 262 rejects the write request. The anchor 241 can be stored as one of the authenticated variables in the protected storage 214, ensuring that the anchor 241 cannot be modified or replaced by the operating system 223 or by malicious software without possessing the corresponding private key for the authenticated write mechanism (e.g., by malicious software that does not satisfy the cryptographic authorization requirements of the authenticated write mechanism).

During the boot phase, the processor 202 executes the firmware 262 from the trusted storage 216. The firmware 262 can be the first code that the processor 202 executes after a platform reset or power-on event. The firmware 262 may initialize the hardware components of the computing system, including the processor 202, volatile memory, and input/output interfaces. After hardware initialization, the firmware 262 may proceed to verify the integrity of the payload 221 stored on the unprotected storage 212. The firmware 262 may read the payload 221 and the digital signature 222 from the unprotected storage 212. The firmware 262 may locate the payload 221 at a predefined path on the unprotected storage 212, such as a file at a known directory location on a partition of a disk storage device. Alternatively, the firmware 262 may use a location identifier stored in the protected storage 214 to locate the payload 221, or the firmware 262 may scan the unprotected storage 212 for a file matching a predefined magic number or header structure. The firmware 262 can read both the payload 221 and the digital signature 222 into volatile memory for processing.

The firmware 262 causes the processor 202 to verify the digital signature 222 using the cryptographic key 261 stored in the trusted storage 216. The verification operation takes the payload 221, the digital signature 222, and the cryptographic key 261 as inputs. The firmware 262 invokes a cryptographic library or a hardware cryptographic accelerator to perform the signature verification. The cryptographic library may implement RSA signature verification using PKCS#1 v2.1 (RSASSA-PSS or RSASSA-PKCS1-v1_5), ECDSA signature verification using a NIST curve (P-256 or P-384), or another asymmetric signature scheme. The verification operation determines whether the digital signature 222 was produced by the private key corresponding to the cryptographic key 261 over the byte range covered by the digital signature 222. If the verification succeeds, the firmware 262 has established that the payload 221 was signed by an authorized entity (the holder of the private key) and that the payload 221 has not been modified since signing. If the verification fails, the firmware 262 does not create an anchor value and the payload 221 is not accepted — the computing system operates with default configuration values or without the functionality that the payload 221 would have provided.

Upon successful verification of the digital signature 222, the firmware 262 causes the processor 202 to compute a first cryptographic hash value of the payload 221. The hash computation may take as input the byte range of the payload 221 that is covered by the digital signature 222 (e.g., the same defined byte domain of the payload 221 that was used for signature verification). In examples in which the payload 221 is stored as a file including a header section, a data section, and a signature section, the hash computation may be performed over the header section and the data section, excluding the signature section. The firmware 262 can invoke a cryptographic hash function, such as SHA-256 (Secure Hash Algorithm 256-bit, producing a 32-byte output) or SHA-384 (producing a 48-byte output), to compute the first cryptographic hash value. The hash function processes the input bytes through a series of compression operations and produces a fixed-length digest that is unique to the input (e.g., corresponding to the input byte domain). Any modification to even a single byte of the payload 221 produces a different hash value. The firmware 262 may invoke the hash function through a software cryptographic library linked into the firmware 262, or through a hardware hash accelerator provided by the chipset or by a TPM. The first cryptographic hash value may be computed after signature verification, ensuring that the hash value corresponds to a payload 221 whose authenticity has been confirmed.

The firmware 262 may further cause the processor 202 to store the first cryptographic hash value as the anchor value, the anchor 241, in the protected storage 214. The storage operation is an authenticated write to the protected storage 214. In a UEFI embodiment, the firmware 262 may invoke a firmware interface, for example, call the SetVariable() runtime service with the variable name and GUID identifying the anchor 241 with relevant variable attributes, for example, the variable attributes including EFI_VARIABLE_NON_VOLATILE, EFI_VARIABLE_BOOTSERVICE_ACCESS, EFI_VARIABLE_RUNTIME_ACCESS, and EFI_VARIABLE_TIME_BASED_AUTHENTICATED_WRITE_ACCESS, and the variable data containing the first cryptographic hash value. The authenticated write access mechanism of the protected storage 214 may validate the write request before committing the anchor 241. Once stored, the anchor 241 persists across reboots of the computing system. The anchor 241 can remain in the protected storage 214 until explicitly updated or deleted through a subsequent authenticated write operation. The anchor 241 thereby represents the last known-good state of the payload 221 as established by the firmware 262 through digital signature verification (e.g., during anchor creation or refresh).

The processor 202 may be further configured to validate, in response to a received access request to the payload 221, the payload 221 by comparing a second cryptographic hash value with the first cryptographic hash value stored as the anchor 241 in the protected storage 214. The access request may be a request by a software component to read and/or use the payload 221. The software component may be the firmware 262 during the boot phase or a runtime software component during the runtime phase. The access request can trigger the validation operation before the payload 221 is consumed. The processor 202 does not apply, execute, or otherwise use the payload 221 until the validation operation completes successfully. The validation operation may be independent of the digital signature 222. In other words, the processor 202 does not verify the digital signature 222 during validation. The validation operation may use only the anchor 241 and the payload 221 as inputs, which can eliminate the need for the consuming software component to have access to the cryptographic key 261 or to any asymmetric key material.

The validation operation may proceed as follows. First, the processor 202 may read the payload 221 from the unprotected storage 212 into volatile memory. Then, the processor 202 computes a second cryptographic hash value over the payload 221 using the same hash function and over the same byte range that the firmware 262 used when computing the first cryptographic hash value during the boot phase. The processor 202 can read the anchor 241 from the protected storage 214, which contains the first cryptographic hash value. The processor 202 may compare the second cryptographic hash value with the first cryptographic hash value. The comparison can be performed using a constant-time comparison algorithm to prevent timing side-channel attacks. If the second cryptographic hash value matches the first cryptographic hash value, the payload 221 is accepted as valid. This would be an indication of that the payload 221 has not been modified since the firmware 262 last verified the digital signature 222. If the second cryptographic hash value does not match the first cryptographic hash value, the processor 202 rejects the payload 221 (or the access request). For example, the consuming component may fall back to predetermined default behavior, such as the processor 202 may apply a default configuration or operating without the functionality that the payload 221 would have provided.

The two-stage mechanism illustrated herein separates trust establishment from trust validation. Illustratively, trust establishment occurs when the firmware 262 verifies the digital signature 222 and stores the anchor 241 during the boot phase, or when an authorized operating system update process verifies a replacement digital signature and then refreshes the anchor 241 through an authenticated runtime update. Trust validation occurs whenever a component issues an access request and the processor 202 compares a freshly computed hash with the anchor 241. The asymmetric cryptographic operation (signature verification) is performed when the anchor 241 is established or refreshed, rather than at each subsequent consumption event. All subsequent validations are symmetric hash computations followed by a comparison, which are computationally inexpensive relative to signature verification. The firmware 262 and the consuming components need not share any secret key material. The consuming components use only the anchor 241 which is a hash value, not a key. The anchor 241 in the protected storage 214 can serve as a persistent bridge between the boot phase and the runtime phase. In other words, a runtime software component that was not executing at the time of signature verification can nonetheless validate the payload 221 by reading the anchor 241 that the firmware 262 or the authorized update process most recently published through the authenticated write path.

In an example, the unprotected storage 212 includes a partition on a disk storage device. The partition is accessible to the firmware 262 during the boot phase and is accessible to the operating system 223 during the runtime phase. The disk storage device may be a hard disk drive, a solid-state drive, an NVMe (Non-Volatile Memory Express) storage device, or an eMMC (embedded Multi-Media Controller) storage device. The partition can be formatted with a file system that both the firmware 262 and the operating system 223 can read, such as a FAT32 (File Allocation Table 32-bit) file system. The firmware 262 may access the partition through a block I/O protocol or a file system protocol provided by the firmware's boot services. The operating system 223 can access the same partition through standard file system drivers. The payload 221 and the digital signature 222 may be stored as one or more files on the partition. Because the partition is accessible to the operating system 223, the operating system 223 or any process running under the operating system 223 with sufficient privileges can read, modify, replace, or delete the payload 221 and the digital signature 222.

In an example, the partition is an Extensible Firmware Interface (EFI) system partition or a Unified EFI (UEFI) system partition. The EFI system partition may refer to a standardized partition type defined by the UEFI specification, formatted with the FAT32 file system, and identified by a specific partition type GUID. The EFI system partition is designed to be accessible to both UEFI firmware during the boot phase and to the operating system during the runtime phase. The firmware 262 can locate the EFI system partition by scanning the GUID Partition Table (GPT) of the disk storage device for the partition type GUID. The payload 221 may be stored at a predefined path within the EFI system partition, such as \EFI\Vendor\payload.bin, where "Vendor" identifies the OEM or the platform vendor. The EFI system partition may commonly be used in UEFI-based computing platforms to store boot loaders, firmware update capsules, and other boot-time data, making the EFI system partition a natural location for the payload 221 that must be accessible to the firmware 262 during the boot phase.

In an example, the firmware 262 may cause the processor 202 to extract a version identifier from the payload 221 and store the version identifier in the protected storage 214 together with the first cryptographic hash value as the anchor 241. The version identifier may be a value embedded in a header of the payload 221, placed at a predefined offset within the payload structure. The version identifier may represent the revision of the payload 221 as assigned by the signing entity (OEM). The firmware 262 reads the version identifier from the header of the payload 221 after successful verification of the digital signature 222 and before storing the anchor 241. The anchor 241 thereby can include a composite record containing at least the first cryptographic hash value and the version identifier. The version identifier may be a monotonically increasing integer value. The firmware 262 may enforce an anti-rollback policy by comparing the version identifier extracted from the payload 221 with a version identifier previously stored in the anchor 241 in the protected storage 214, and rejecting the payload 221 if the extracted version identifier is lower than the stored version identifier. The anti-rollback policy prevents an attacker from replacing the payload 221 with an older, validly signed version that may contain a known security vulnerability.

In an example, the anchor value 241 stored in the protected storage 214 may further include one or more optional metadata fields in addition to the first cryptographic hash value and the version identifier. The anchor value 241 may include a hash algorithm identifier identifying the cryptographic hash function used to compute the first cryptographic hash value, enabling the firmware 262 and consuming components to determine the correct hash function to apply during validation. The anchor value 241 may include a key identifier identifying which cryptographic key 261 the firmware 262 used to verify the digital signature 222, supporting key rotation across product lifecycles. The anchor value 241 may include a location identifier including an advisory pointer to the payload 221 on the unprotected storage 212, such as a file path or a GUID, enabling the firmware 262 and consuming components to locate the payload 221 without scanning the unprotected storage 212; the integrity of the payload 221 is enforced by the first cryptographic hash value, not by the location identifier. The anchor value 241 may include a timestamp recording the time at which the anchor value 241 was last established or updated, encoded as a UNIX epoch value. The anchor value 241 can thereby form a composite record in the protected storage 214 whose mandatory field is the first cryptographic hash value and whose optional fields may include any combination of version identifier, hash algorithm identifier, key identifier, location identifier, and timestamp.

In an example, the firmware 262 causes the processor 202 to determine whether an anchor value is present in the protected storage 214 before verifying the digital signature 222, and the processor 202 uses the anchor value to validate the payload 221. The firmware 262 can issue a read request to the protected storage 214 targeting the variable identified by the predefined GUID and variable name for the anchor 241. The protected storage 214 may return either the stored anchor 241 or an indication that no such variable exists. If the anchor 241 is not present, for example, on a first boot of the computing system, after a factory reset, or after the anchor 241 has been deleted, the firmware 262 can proceed to verify the digital signature 222 as described above, compute the first cryptographic hash value, and create the anchor 241. If the anchor 241 is present, the firmware 262 may use the anchor 241 to validate the payload 221 by computing a hash and comparing, without first performing signature verification. The presence check may enable the firmware 262 to distinguish between a first-boot scenario requiring full signature verification and a steady-state scenario where the anchor 241 already reflects a previously verified payload 221.

In an example, when the anchor 241 is present in the protected storage 214, the firmware 262 may cause the processor 202 to, during a subsequent boot phase: compute a third cryptographic hash value of the payload 221 in the unprotected storage 212, compare the third cryptographic hash value with the first cryptographic hash value stored in the anchor 241 in the protected storage 214, and upon a match, accept the payload 221 without verifying the digital signature 222. The third cryptographic hash value may be computed using the same hash algorithm and over the same byte range as the first cryptographic hash value. The comparison determines whether the payload 221 has changed since the anchor 241 was last established. If the third cryptographic hash value matches the first cryptographic hash value, the processor 202 determines that the payload 221 is unchanged and the firmware 262 accepts the payload 221 without incurring the computational cost of signature verification. The firmware 262 thereby reuses the trust established during a prior boot by relying on the anchor 241 as a persistent record of the last verified state of the payload 221.

In an example, when a mismatch is detected between the third cryptographic hash value and the first cryptographic hash value, the firmware 262 may cause the processor 202 to verify the digital signature 222 of the payload 221, and upon successful verification, compute an updated cryptographic hash value of the payload 221, and replace the first cryptographic hash value stored as the anchor 241 in the protected storage 214 with the updated cryptographic hash value. The mismatch indicates that the payload 221 on the unprotected storage 212 has been modified since the anchor 241 was last established. The modification may result from a legitimate update deployed by an OEM update tool or from unauthorized tampering. The firmware 262 can resolve the ambiguity by performing full signature verification. If the digital signature 222 is valid for the modified payload 221, the firmware 262 computes a new hash value over the modified payload 221 and writes the new hash value to the protected storage 214 as the updated anchor 241 via an authenticated write operation. If the digital signature 222 is invalid, the firmware 262 deletes the anchor 241 from the protected storage 214, causing subsequent consumers to find no anchor value and to fall back to default behavior.

In an example, the access request to the payload 221 may be received from a runtime software component being executed by the processor 202 after the boot phase. The runtime software component may be a device driver, a system service, a daemon, or an application executing under the operating system 223. The runtime software component may read the anchor 241 from the protected storage 214 via a runtime variable access interface. The runtime variable access interface may include at least one of a UEFI variable access interface, an ACPI (Advanced Configuration and Power Interface) method, or a firmware-to-operating-system communication interface.

When the runtime variable access interface is a UEFI variable access interface, the runtime software component may invoke the GetVariable() UEFI runtime service, specifying the GUID and variable name of the anchor 241, to retrieve the anchor value from the protected storage 214. When the runtime variable access interface is an ACPI method, the firmware 262 may expose the anchor 241 through an ACPI namespace object, and the runtime software component can read the anchor value by evaluating the ACPI method via the operating system's ACPI subsystem. When the runtime variable access interface is a firmware-to-operating-system communication interface, the firmware 262 and the operating system 223 communicate through a shared memory region or a mailbox mechanism. The runtime software component can validate the payload 221 by computing a hash and comparing with the anchor 241.

In an example, the access request to the payload 221 is received from the firmware 262 during the boot phase. The firmware 262 itself can act as a consumer of the payload 221. For instance, when the payload 221 contains platform configuration data that the firmware 262 applies during the boot phase to configure a hardware component, a firmware subsystem, or a boot-time protocol, the firmware 262 acts as the consumer. The firmware 262 reads the anchor 241 from the protected storage 214 using internal firmware interfaces (e.g., the GetVariable() boot service in a UEFI environment). The firmware 262 further reads the payload 221 from the unprotected storage 212. The firmware 262 computes a hash of the payload 221, compares the hash with the anchor 241, and applies the payload data only upon a match. The firmware 262 thereby validates the payload 221 before consuming the payload 221, using the same anchor-based validation mechanism that runtime software components use during the runtime phase. The boot-phase access request is distinct from the initial verification and anchor creation described above, such that the boot-phase access request occurs after the anchor 241 has been established (either at the current boot or at a prior boot), and the firmware 262 uses the anchor 241 to validate the payload 221 without re-performing signature verification.

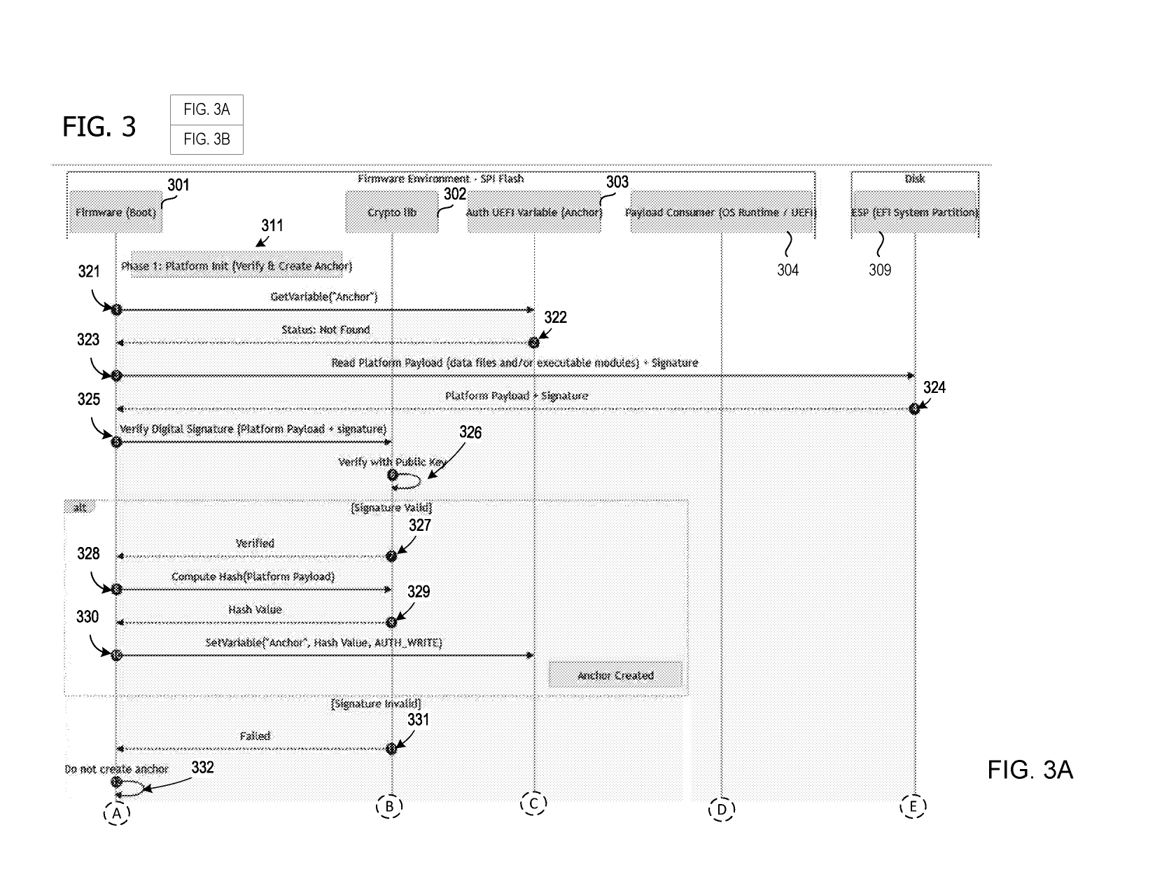

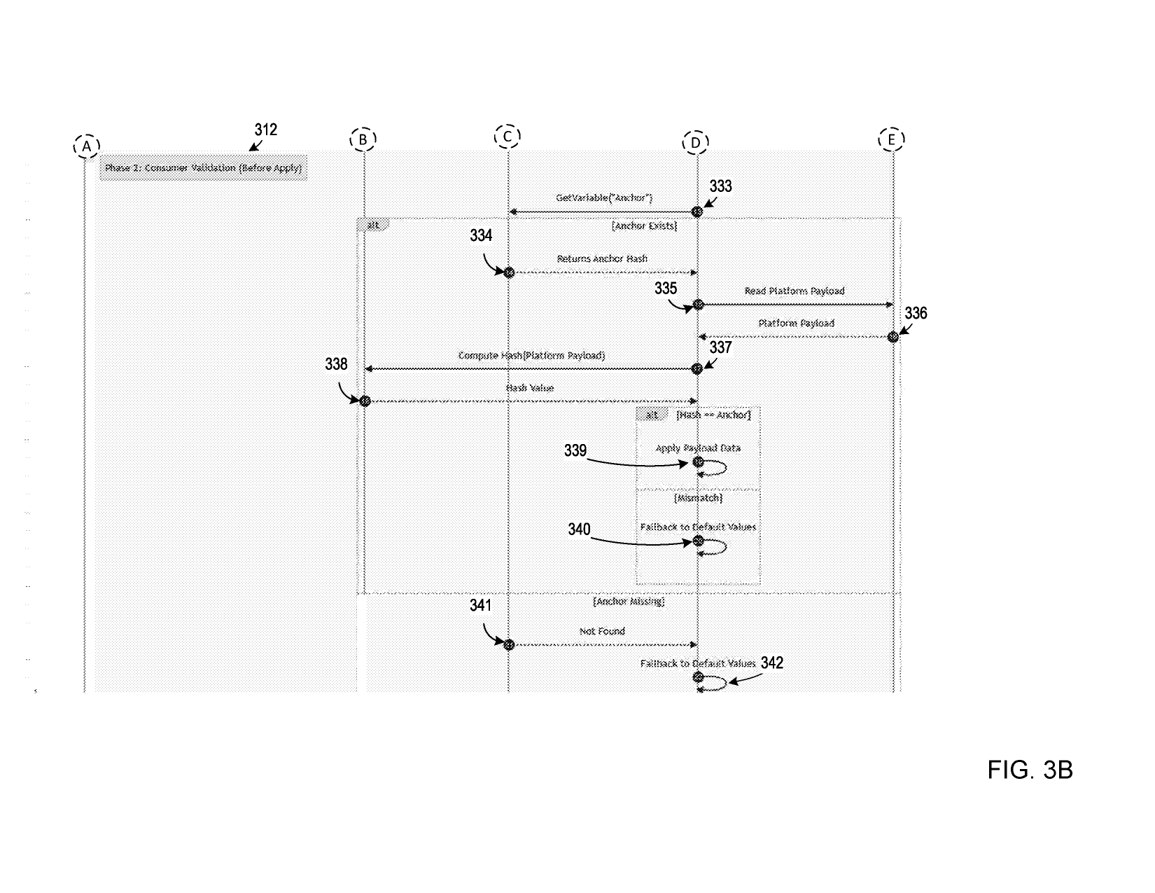

FIG. 3 illustrates a sequence flow for initial provisioning of the computing system when no anchor value is present in the protected non-volatile storage. FIG. 3 is divided into FIG. 3A and FIG. 3B. It is to be recognized that a sequence flow implemented by a computing system as illustrated in FIGS. 1 and 2, may include the complete sequence flow described herein, or only a combination of actions described for the sequence flow. In other words, some of actions described herein may be optional. In an example, the processor 202 may implement the flow.

FIG. 3A involves Phase 1311, in which the firmware establishes trust by verifying the digital signature of the payload and creating the anchor value. FIG. 3B involves Phase 2312, in which a payload consumer validates the payload against the anchor value before applying the payload. The sequence flow may involve five participants or entities: a firmware component 301 (labelled "Firmware (Boot)") executing from the trusted storage during the boot phase, a cryptographic library 302 (labelled "Crypto lib") providing hash computation and signature verification functions, an authenticated UEFI variable store 303 (labelled "Auth UEFI Variable (Anchor)") representing the protected non-volatile storage, a payload consumer 304 (labelled "Payload Consumer (OS Runtime / UEFI)") representing any software component that consumes the payload, and an EFI system partition 309 (labelled "ESP (EFI System Partition)") on disk representing the non-volatile storage. The firmware component 301, the cryptographic library 302, and the authenticated UEFI variable store 303 may reside within the firmware environment on SPI flash. The EFI system partition 309 resides on disk and constitutes untrusted storage.

Phase 1311 begins when the firmware component 301 issues a GetVariable request 321 to the authenticated UEFI variable store 303, requesting the anchor value identified by the variable name "Anchor". The authenticated UEFI variable store 303 may return a status indication 322 of "Not Found" indicating that no anchor value is present in the protected non-volatile storage. This situation can arise on a first boot of the computing system, after a factory reset, or after the anchor value has been deleted due to a prior failed verification. The firmware component 301 determines, based on the "Not Found" response 322, that no anchor value exists against which to validate the payload. In other words, the firmware component 301 may cause the processor to determine whether an anchor value is present in the protected non-volatile storage before verifying the digital signature. In this case, the determination yields a negative result, causing the firmware component 301 to proceed to full digital signature verification of the payload rather than to hash-based validation using an existing anchor value.

The firmware component 301 issues a read request 323 to the EFI system partition 309 to read the platform payload together with the digital signature. The read request 323 targets files at a predefined path on the EFI system partition 309, such as \EFI\Vendor\payload.bin. The payload may include data files and/or executable modules. The EFI system partition 309 returns the platform payload and the digital signature as response 324 to the firmware component 301. The firmware component 301 receives the payload bytes and the signature bytes into volatile memory. The payload may include wireless regulatory parameters for a specific country or region, thermal management profiles defining fan curves and power limits, security policy manifests, or UEFI executable modules such as a Wi-Fi driver image. The digital signature accompanies the payload as a signature footer or as a separate data structure, covering a defined byte range of the payload as established by the signing entity.

The firmware component 301 invokes the cryptographic library 302 with a verify request 325, passing the platform payload and the digital signature as inputs. The verify request 325 initiates digital signature verification of the payload. The cryptographic library 302 performs the verification operation 326 using the public key stored in the trusted storage of the computing system. The verification operation 326 applies the public key to the digital signature and compares the result against a digest of the payload computed internally by the cryptographic library 302. The public key corresponds to the private key held by the original equipment manufacturer or signing entity that produced the digital signature. The cryptographic library 302 may implement RSA signature verification (e.g., RSASSA-PSS with SHA-256) or ECDSA verification (e.g., using NIST P-256 or P-384). The verification operation 326 determines whether the digital signature was produced by the authorized private key over the exact bytes of the payload.

FIG. 3A illustrates two alternative outcomes of the verification operation 326. In the first alternative 327, the signature is valid. The cryptographic library 302 returns a "Verified" indication 328 to the firmware component 301, confirming that the digital signature is authentic and that the payload has not been modified since signing. Upon receiving the "Verified" indication 328, the firmware component 301 invokes the cryptographic library 302 with a hash computation request 329 to compute a cryptographic hash value of the platform payload. The cryptographic library 302 processes the payload bytes through a cryptographic hash function such as SHA-256, producing a 32-byte hash value, or SHA-384, producing a 48-byte hash value. The cryptographic library 302 returns the computed hash value to the firmware component 301. The hash computation request 329 may take as input the same defined byte domain of the payload that was used for signature verification. In examples in which the payload is stored as a file including a header section, a data section, and a signature section, the hash computation request 329 may cover the header section and the data section, excluding the signature section, ensuring consistency between the signed content and the hashed content.

The firmware component 301 issues a SetVariable request 330 to the authenticated UEFI variable store 303. The SetVariable request 330 writes the computed hash value to the protected non-volatile storage as the anchor value, with the variable name "Anchor" and the authenticated write attribute AUTH_WRITE. The authenticated write attribute ensures that subsequent modifications to the anchor value require cryptographic authorization. The authenticated UEFI variable store 303 validates the write request and commits the anchor value to non-volatile storage. FIG. 3A indicates this outcome with the annotation "Anchor Created". The anchor value persists across reboots of the computing system. In an example, the firmware component 301 also extracts a version identifier from the header of the payload and stores the version identifier in the protected non-volatile storage together with the hash value as the anchor value, forming a composite record. The version identifier is a monotonically increasing integer assigned by the signing entity, enabling anti-rollback enforcement on subsequent boots.

In a specific implementation, and referring back to FIG. 2, the version identifier stored in the protected storage 214 as part of the anchor value 241 may occupy a four-byte field at byte offset 0x04 within the anchor value 241 data structure, designated PayloadVersion, encoded as a little-endian unsigned 32-bit integer. The firmware component 301 can read the PayloadVersion field from the header of the payload at a predefined offset within the payload file structure before issuing the SetVariable request 330. The hash computation performed by the firmware component 301 to produce the first cryptographic hash value may cover a defined byte domain of the payload including the header section and the data section of the payload file; the signature footer of the payload, which contains the signature algorithm identifier, the key identifier, the signature length field, and the signature bytes, is excluded from the hash domain. The firmware component 301 and each payload consumer 304 may apply the cryptographic hash function over the same byte domain, as in the header section and the data section, to avoid false mismatches during validation. The hash domain is deterministic and fixed by the payload file format, and may not be affected by the length or content of the signature footer.

In the second alternative 331, the signature is invalid. The cryptographic library 302 returns a "Failed" indication to the firmware component 301. The firmware component 301, upon receiving the "Failed" indication, does not create the anchor value in the protected non-volatile storage, as indicated by the action 332 "Do not create anchor”. The firmware component 301 does not compute a hash of the payload and does not issue a SetVariable request. The payload is not accepted. The computing system proceeds to operate without the payload — any consumer that subsequently requests the payload will find no anchor value in the protected non-volatile storage and will fall back to predetermined default behavior. The signature failure may result from the payload having been tampered with, from the payload having been signed with a key not corresponding to the public key in the trusted storage, or from corruption of the payload or signature during storage or transfer.

FIG. 3B illustrates Phase 2312, which represents consumer validation. Phase 2312 may occur during the same boot phase (for firmware consumers) or during the runtime phase (for operating system consumers). The payload consumer 304 issues a GetVariable request 333 to the authenticated UEFI variable store 303, requesting the anchor value by variable name "Anchor". FIG. 3B illustrates three alternative branches depending on the state of the anchor value. In the first alternative 334, the anchor value exists in the protected non-volatile storage. The authenticated UEFI variable store 303 returns the stored anchor hash 334 to the payload consumer 304. The payload consumer 304 may be a runtime software component such as a device driver, a system service, or an application executing under the operating system after the boot phase, reading the anchor value via a runtime variable access interface. The runtime variable access interface may include a UEFI variable access interface (GetVariable() runtime service), an ACPI method exposed by the firmware, or a firmware-to-operating-system communication interface such as a shared memory region.

Upon receiving the anchor hash, the payload consumer 304 issues a read request 335 to the EFI system partition 309 to read the platform payload. The EFI system partition 309 returns the platform payload 336 to the payload consumer 304. The payload consumer 304 then invokes the cryptographic library 302 with a hash computation request 337 to compute a cryptographic hash value of the platform payload. The cryptographic library 302 computes the hash over the same byte range and using the same hash algorithm that the firmware component 301 used during Phase 1311 — this consistency is essential because any difference in the hash domain would produce a false mismatch. The cryptographic library 302 returns the computed hash value 338 to the payload consumer 304. The payload consumer 304 does not perform digital signature verification — the payload consumer 304 has no access to the cryptographic key in the trusted storage and does not require such access, because the anchor value already represents the result of a prior signature verification performed by the firmware component 301.

The payload consumer 304 may perform the comparison between the computed hash value 338 and the anchor hash using a constant-time comparison algorithm that evaluates all bytes of both values regardless of where the first differing byte occurs, such that the duration of the comparison does not vary with the content of either value. Referring back to FIG. 2, the payload consumer 304 performs the sequence including reading the anchor value 241 from the protected storage 214, reading the payload 221 from the unprotected storage 212, computing the hash value 338, performing the constant-time comparison, and either applying the payload data or falling back to default values as a continuous, uninterrupted sequence of operations executed immediately prior to using the payload 221. In various embodiments, to mitigate time-of-check-to-time-of-use risks, the payload consumer 304 may be configured such that it does not introduce any delay or yield point between completing the hash comparison and applying or rejecting the payload 221. This sequencing can ensure that the bytes that the payload consumer 304 hashes are the same bytes that the payload consumer 304 subsequently applies, and that the interval between comparison and use is not exploitable by a concurrent process that might modify the payload 221 on the unprotected storage 212 between the two operations.

FIG. 3B illustrates two alternative outcomes of the comparison between the computed hash value 338 and the anchor hash. In the first alternative, the hash matches the anchor value (labelled "Hash == Anchor"). The payload consumer 304 applies the payload data 339 — the payload consumer 304 reads the platform-specific data from the payload and uses the data to configure a function of the computing system. In an example, the payload includes platform configuration data, and the processor, upon successful validation, applies the platform configuration data to configure a function of the computing system during the boot phase. For instance, a UEFI Wi-Fi driver module executing during the boot phase may apply wireless regulatory parameters from the payload to configure transmit power limits and channel availability for a specific country. The application of configuration data occurs only after the hash comparison succeeds — the payload consumer 304 does not apply any data from the payload before validation completes.

In the second alternative, the hash does not match the anchor value (labelled "Mismatch"). The payload consumer 304 falls back to default values 340. The fallback behavior depends on the nature of the payload consumer 304. For a wireless regulatory driver, the default values may include the most restrictive regulatory parameters, ensuring compliance in the absence of verified country-specific configuration. For a thermal management module, the default values may include conservative thermal profiles with reduced performance limits. The fallback ensures that the computing system remains operational and safe even when the payload cannot be validated. The mismatch may result from the payload having been modified after the anchor value was established — for example, if the payload file was replaced on the EFI system partition 309 by the operating system, by an update tool, or by malicious software after the firmware component 301 created the anchor value during the boot phase.

In the third alternative 341, the anchor value is missing from the protected non-volatile storage — the authenticated UEFI variable store 303 returns a "Not Found" indication to the payload consumer 304. The payload consumer 304 falls back to default values 342 without attempting to read the payload from the EFI system partition 309 or to compute a hash. The anchor value may be missing because the digital signature verification failed during Phase 1311 (and the firmware component 301 did not create the anchor value), because the computing system has not yet completed Phase 1311 (an unlikely race condition in sequential boot flows), or because the anchor value was deleted during a prior boot due to a failed re-verification of a replacement payload. In this third alternative, because no anchor value is available, the payload consumer 304 does not attempt to validate or use the payload and instead falls back immediately to the default values 342.

Referring back to FIG. 2, when the protected storage 214 returns a Not Found indication in response to the GetVariable request for the anchor value 241, the payload consumer 304 can fall back to predetermined default values without reading the payload 221 from the unprotected storage 212 and without performing any hash computation. The predetermined default values may be the most restrictive parameter values applicable to the function that the payload 221 configures. In an example, when the payload 221 contains wireless regulatory parameters specifying permitted transmit power levels and channel availability for a specific country or regulatory domain, the predetermined default values may include the most restrictive transmit power limits and the narrowest set of permitted radio channels among all regulatory domains in which the computing platform may be deployed, ensuring that the wireless interface of the computing system operates within applicable regulatory limits in the absence of verified country-specific configuration. In an example, when the payload 221 includes thermal management profiles, the predetermined default values may include conservative thermal thresholds with reduced performance limits, ensuring safe thermal operation. The fallback to predetermined default values allows the computing system to remain operational when no anchor value 241 is present in the protected storage 214, including on a first boot before the firmware component 301 has established the anchor value 241, after a factory reset, or after the anchor value 241 has been deleted.

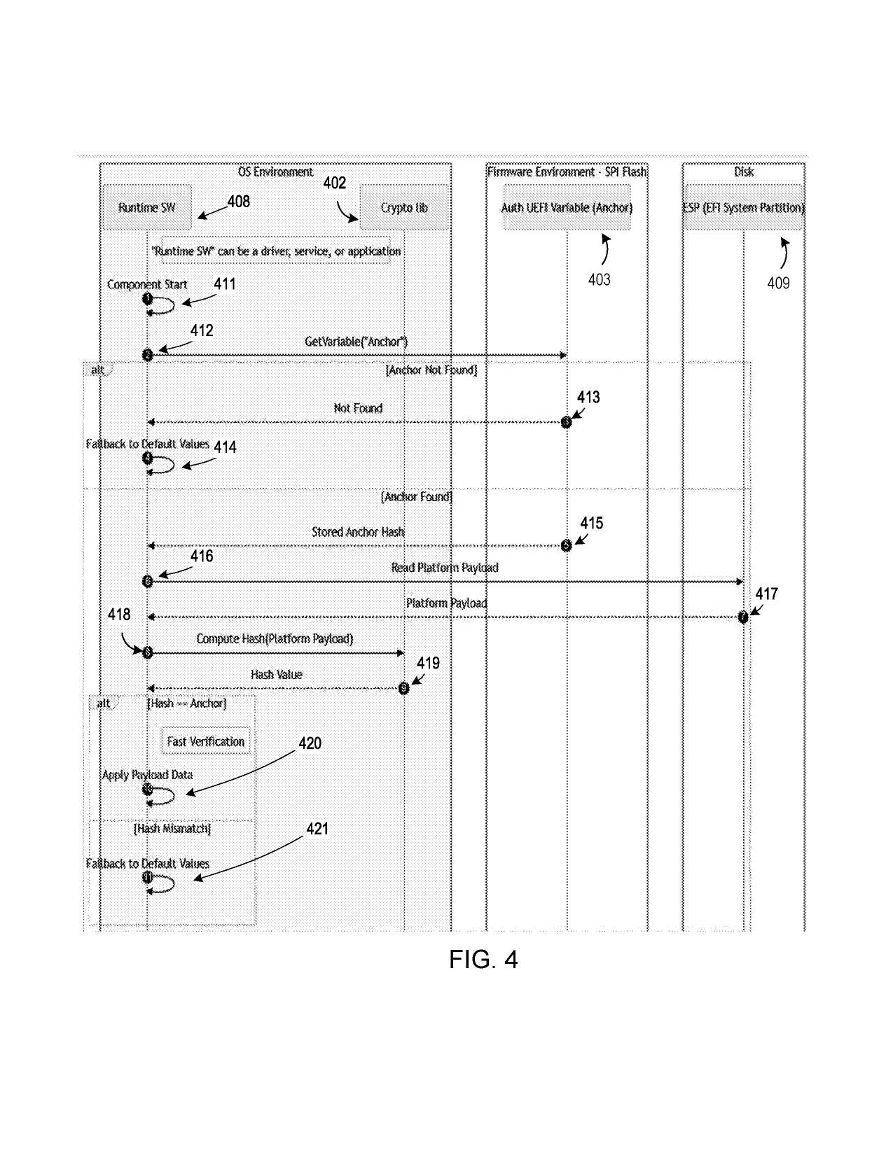

FIG. 4 illustrates a sequence flow for validation of the payload 221 stored in the non-volatile storage 212 by a runtime software component during the runtime phase. The sequence flow of FIG. 4 can involve the runtime software component 408 and a cryptographic library 402, both executing within the OS environment. The sequence flow may further include the protected non-volatile storage represented by the authenticated UEFI variable store 403, and the non-volatile storage storing the EFI system partition 409. The runtime software component 408 may be a device driver, a system service, or an application executing under the operating system after the boot phase. The sequence flow begins at 411, in which the runtime software component 408 starts. Upon starting, the runtime software component 408 issues an access request to the payload 221 by issuing a GetVariable call 412 directed to the authenticated UEFI variable store 403, specifying the variable name and GUID associated with the anchor value 241, before reading or applying any data from the payload 221.

In an example, the runtime software component 408 reads the anchor value 241 from the protected non-volatile storage 214 via a runtime access interface that may include at least one of a UEFI variable access interface, an ACPI method, or a firmware-to-operating-system communication interface. When the runtime access interface is a UEFI variable access interface, the runtime software component 408 may invoke the GetVariable() UEFI runtime service specifying the GUID and variable name of the anchor value 241, as illustrated by the GetVariable call 412. When the runtime access interface is an ACPI method, the firmware 262 may expose the anchor value 241 through an ACPI namespace object, and the runtime software component 408 may read the anchor value 241 by evaluating the ACPI method through the operating system's ACPI subsystem. When the runtime access interface is a firmware-to-operating-system communication interface, the firmware 262 may communicate the anchor value 241 to the runtime software component 408 through a shared memory region or a mailbox mechanism established during the boot phase.

In the first alternative branch, labelled "Anchor Not Found", the authenticated UEFI variable store 403 returns a Not Found indication 413 to the runtime software component 408, indicating that no anchor value 241 is present in the protected non-volatile storage 214. The runtime software component 408, upon receiving the Not Found indication 413, performs a fallback to default values at 414. The runtime software component 408 does not attempt to read the payload 221 from the non-volatile storage 212 and does not compute a cryptographic hash value. The runtime software component 408 instead operates using predetermined default values for the function that the payload 221 would have configured. The anchor value 241 may be absent from the protected non-volatile storage 214 because digital signature verification of the payload 221 failed during a prior boot phase, because the anchor value 241 was deleted during a prior boot phase due to a failed re-verification of a replacement payload, or because the computing system has not yet completed an initial provisioning boot.

In the second alternative branch of FIG. 4, labelled "Anchor Found", the authenticated UEFI variable store 403 returns the stored anchor hash at 415 to the runtime software component 408, delivering the first cryptographic hash value included by the anchor value 241. Upon receiving the stored anchor hash at 415, the runtime software component 408 issues a read request at 416 to the EFI system partition 409. The EFI system partition 409 returns the payload 221 as response 417 to the runtime software component 408. The runtime software component 408 reads the payload 221 into volatile memory for hash computation. The runtime software component 408 does not verify the digital signature 222 of the payload 221 at this stage and does not require access to the cryptographic key 261 stored in the trusted storage 216, because the anchor value 241 stored in the protected non-volatile storage 214 represents the result of a prior digital signature verification performed by the firmware 262 during a boot phase.

The runtime software component 408 invokes the cryptographic library with a hash computation request at 418, passing the payload 221 as input. The cryptographic library computes a second cryptographic hash value over the same byte domain and using the same hash algorithm as the firmware 262 applied when computing the first cryptographic hash value during the boot phase, and returns the second cryptographic hash value at 419 to the runtime software component 408. The runtime software component 408 compares the second cryptographic hash value with the first cryptographic hash value received as the stored anchor hash. In the first alternative of the comparison, labelled "Hash == Anchor" in FIG. 4, the comparison yields a match and the runtime software component 408 applies the payload data in a fast verification at 420. The runtime software component 408 may read platform configuration data from the payload 221 and apply the platform configuration data to configure a function of the computing system during the runtime phase.

In the second alternative of the comparison, labelled "Hash Mismatch" in FIG. 4, the second cryptographic hash value does not match the first cryptographic hash value included by the anchor value 241, and the runtime software component 408 falls back to default values at 421 without applying any data from the payload 221. The mismatch may result from the payload 221 having been modified on the non-volatile storage 212 after the anchor value 241 was last established by the firmware 262, for example by a replacement payload having been written to the EFI system partition 409 by an update tool or by an operating system process after the most recent boot phase. The runtime software component 408 requires only the anchor value 241 from the protected non-volatile storage 214 and the hash computation capability of the cryptographic library to perform the validation. The runtime software component 408 does not require access to the cryptographic key 261 or to any asymmetric key material, and the validation performed by the runtime software component 408 is independent of the digital signature 222.

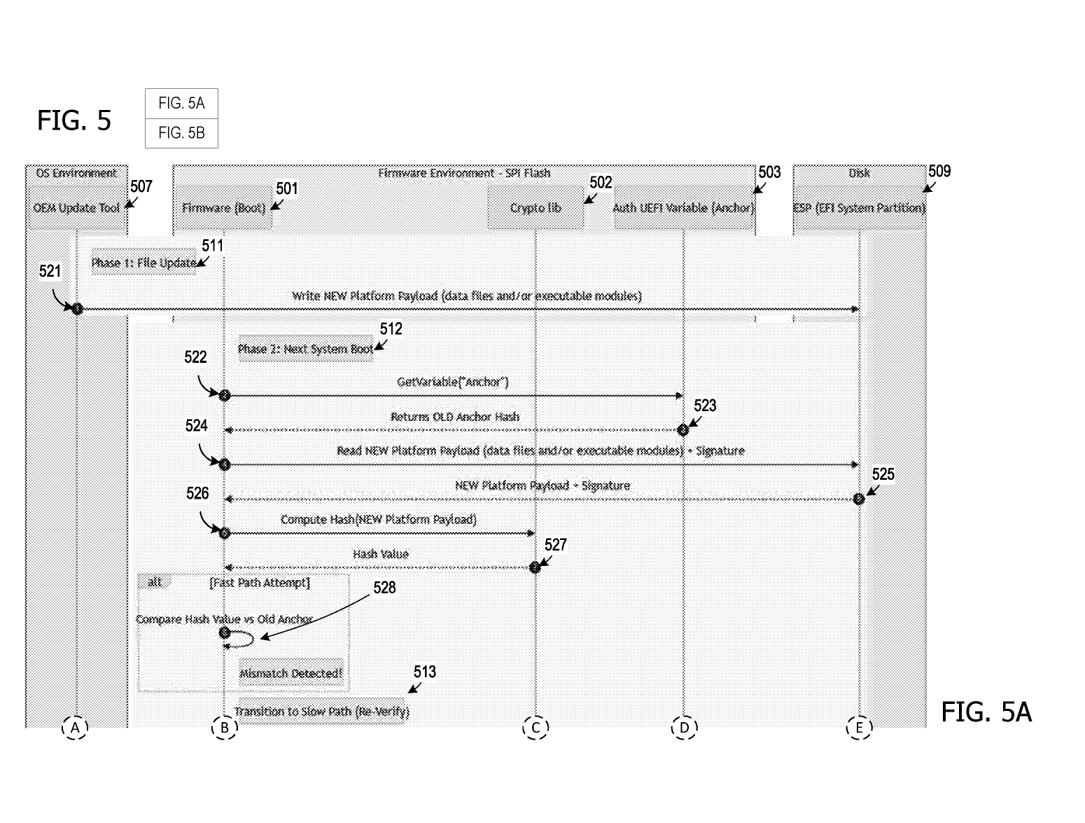

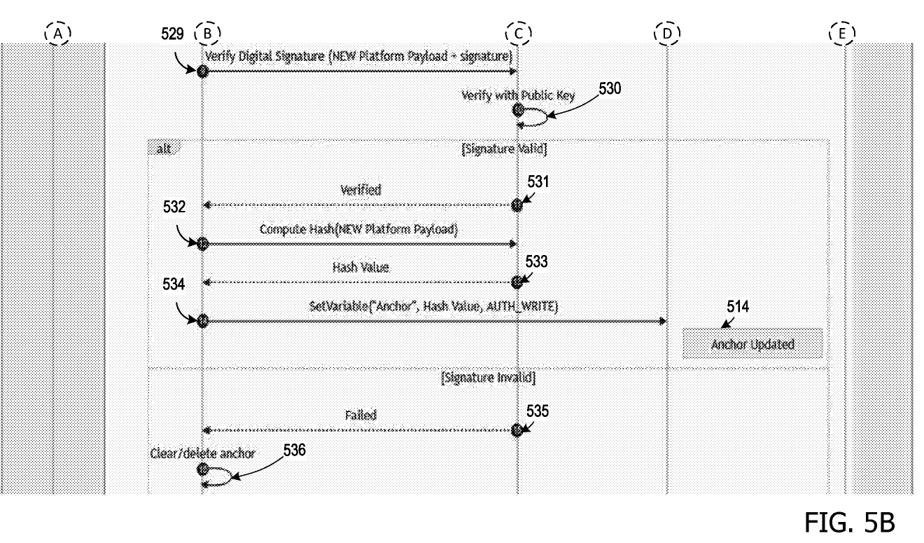

FIG. 5A and FIG. 5B together illustrate a sequence flow for a reboot-based update of the payload 221 stored in the non-volatile storage 212. The sequence flow of FIG. 5 may involve an OEM update tool 507 executing as an operating system process, a firmware component 501 executing from the trusted storage 216 during the boot phase, a cryptographic library 502 providing hash computation and signature verification functions, the protected non-volatile storage storing the authenticated UEFI variable store 503, and the non-volatile storage storing the EFI system partition 509. The sequence flow begins in Phase 1511, labelled "File Update" in FIG. 5A. The OEM update tool 507 writes a replacement payload, which may include replacement data files and/or replacement executable modules, together with a corresponding replacement digital signature to the EFI system partition 509, as shown by the write operation 521. The OEM update tool 507 may perform the write operation 521 as a standard file system write operation without modifying the trusted storage 216, without reflashing any firmware, and without issuing any authenticated write to the protected non-volatile storage 214.

Phase 2512, labelled "Next System Boot" in FIG. 5A, begins when the computing system is subsequently restarted and the firmware component 501 executes from the trusted storage 216 during the boot phase. The firmware component 501 issues a GetVariable request at 522 to the authenticated UEFI variable store 503, specifying the variable name and GUID identifying the anchor value 241. The authenticated UEFI variable store 503 returns the OLD anchor hash at 523 to the firmware component 501, indicating that the anchor value 241 is already present in the protected non-volatile storage 214 from a prior boot phase. In an example, the firmware component 501 determines whether the anchor value 241 is present in the protected non-volatile storage 214 before verifying the digital signature 222 of the payload, and uses the anchor value 241 to validate the payload 221 when the anchor value 241 is found to be present. The firmware component 501, having determined from the returned response that the anchor value 241 is present, proceeds to read the replacement payload and its replacement digital signature from the non-volatile storage 212.

The firmware component 501 issues a read request at 524 to the EFI system partition 509, requesting the replacement payload together with the replacement digital signature. The EFI system partition 509 returns the replacement payload and the replacement digital signature as response at 525 to the firmware component 501. The firmware component 501 invokes the cryptographic library 502 with a hash computation request at 526, passing the replacement payload as input. The cryptographic library 502 computes a third cryptographic hash value over the replacement payload, applying the same hash algorithm and over the same byte domain as the first cryptographic hash value stored in the anchor value 241, and returns the third cryptographic hash value at 527 to the firmware component 501. In an example, the firmware component 501 computes the third cryptographic hash value of the payload 221 in the non-volatile storage 212 during a subsequent boot phase in which the anchor value 241 is already present in the protected non-volatile storage 214, and upon a match between the third cryptographic hash value and the first cryptographic hash value stored as the anchor value 241, accepts the payload 221 without verifying the digital signature 222.

The firmware component 501 performs a fast path attempt, shown as the alternative branch labelled "Fast Path Attempt" in FIG. 5A, by comparing, at 528, the computed third cryptographic hash value with the OLD anchor hash. The firmware component 501 executes this comparison as a self-call 528. The comparison yields a mismatch, annotated as "Mismatch Detected!", because the replacement payload written to the non-volatile storage 212 in Phase 1511 differs from the payload 221 from which the firmware component 501 last derived the anchor value 241. The firmware component 501 transitions from the fast path to the slow path, as indicated by the annotation 513 "Transition to Slow Path (Re-Verify)" in FIG. 5A, and proceeds to digital signature verification of the replacement payload and its replacement digital signature rather than accepting the replacement payload on the basis of the existing anchor value 241.

In an example, upon detecting a mismatch between the third cryptographic hash value computed over the replacement payload and the first cryptographic hash value included by the anchor value 241, the firmware component 501 verifies the digital signature of the replacement payload and, upon successful verification, updates the anchor value 241 in the protected non-volatile storage 214. The firmware component 501 invokes the cryptographic library 502 with a verify request at 529, passing the replacement payload and its replacement digital signature as inputs, as shown in FIG. 5B. The cryptographic library 502 performs a self-call at 530 labelled "Verify with Public Key" to apply the cryptographic key 261 stored in the trusted storage 216 to the replacement digital signature, determining whether the replacement digital signature was produced by the corresponding private key over the defined byte domain of the replacement payload.

In the first alternative of the verification operation, labelled "Signature Valid" in FIG. 5B, the cryptographic library 502 returns a Verified indication at 531 to the firmware component 501. Upon receiving the Verified indication, the firmware component 501 invokes the cryptographic library 502 with a second hash computation request at 532. The cryptographic library 502 computes an updated cryptographic hash value over the replacement payload and returns the updated cryptographic hash value at 533 to the firmware component 501. The firmware component 501 issues a SetVariable request at 534 to the authenticated UEFI variable store 503, specifying the variable name and GUID of the anchor value 241, the AUTH_WRITE authenticated write attribute, and the updated cryptographic hash value as the new anchor value data. The authenticated UEFI variable store 503 validates the write request and commits the updated anchor value 241 to the protected non-volatile storage 214, as indicated by the annotation "Anchor Updated" 514 in FIG. 5B. The firmware component 501 thereby replaces the first cryptographic hash value stored as the anchor value 241 in the protected non-volatile storage 214 with the updated cryptographic hash value computed over the verified replacement payload.

In an example, when the anchor value 241 includes version identifier together with the first cryptographic hash value, the firmware component 501 may extract a version identifier from the replacement payload before issuing the SetVariable request at 534. The firmware component 501 may compare the version identifier extracted from the replacement payload with the version identifier included by the existing anchor value 241. The firmware component 501 may proceed with the SetVariable request at 534 only if the version identifier extracted from the replacement payload is not lower than the version identifier included by the existing anchor value 241. If the version identifier extracted from the replacement payload is lower than the version identifier included by the existing anchor value 241, the firmware component 501 may decline to update the anchor value 241 notwithstanding that the replacement digital signature is valid. The updated anchor value 241 committed during the SetVariable request at 534 may include the updated cryptographic hash value together with the version identifier extracted from the replacement payload.

In the second alternative of the verification operation, labelled "Signature Invalid" in FIG. 5B, the cryptographic library 502 returns a Failed indication at 535 to the firmware component 501. The firmware component 501, upon receiving the Failed indication at 535, issues a deletion request at 536 to the authenticated UEFI variable store 503 to delete the anchor value 241 from the protected non-volatile storage 214, as shown by the action 536 labelled "Clear/delete anchor" in FIG. 5B. The firmware component 501 does not compute an updated cryptographic hash value and does not write any new value to the protected non-volatile storage 214 as the anchor value 241. The protected non-volatile storage 214 thereafter holds no anchor value 241 for the payload 221. Any runtime software component 408 that subsequently issues an access request to the payload 221 will find the protected non-volatile storage 214 returning a Not Found indication and will fall back to predetermined default values as described with reference to FIG. 4. The signature failure may result from the replacement payload having been tampered with, from the replacement payload having been signed with a private key not corresponding to the cryptographic key 261 in the trusted storage 216, or from corruption of the replacement payload or the replacement digital signature.

In an example, the firmware component 501 may be configured by platform policy to bypass the fast path hash comparison shown at 528 in FIG. 5A on a given boot phase and instead verify the digital signature 222 of the payload 221 directly. In this alternative embodiment, the firmware component 501 proceeds directly to digital signature verification on the selected boot phase even though the anchor value 241 is already present in the protected non-volatile storage 214 and regardless of whether the payload 221 has changed since the anchor value 241 was last established. The firmware component 501 does not compute the third cryptographic hash value for comparison with the existing anchor value 241 before performing digital signature verification. Upon successful verification of the digital signature 222, the firmware component 501 computes a cryptographic hash value of the payload 221 and stores the cryptographic hash value as the updated anchor value 241 in the protected non-volatile storage 214 via an authenticated write operation, overwriting any previously stored anchor value 241. Upon a failed verification, the firmware component 501 may delete any existing anchor value 241 from the protected non-volatile storage 214.

The update ordering enforced by the sequence flow of FIG. 5 may require the OEM update tool 507 to write the replacement payload and the replacement digital signature to the non-volatile storage 212 before the anchor value 241 in the protected non-volatile storage 214 is updated to reflect the replacement payload. The write operation at 521 of Phase 1511 precedes the anchor value update at 534 of Phase 2512, with a reboot cycle separating the two events. Any intermediate state arising after the write operation 521 has completed but before the anchor value 241 has been updated results in a hash mismatch at 528, causing the firmware component 501 to perform digital signature verification rather than silently accepting the replacement payload. This may happen, for example, if the computing system is restarted prior to the boot in which Phase 2 512 executes. The file-write-first ordering thereby ensures that no intermediate state produces acceptance of a payload 221 whose digital signature has not been verified by the firmware component 501 during the current or a prior boot phase. The OEM update tool 507 may write the replacement payload and the replacement digital signature as a single atomic file system operation if the file system of the non-volatile storage 212 supports such atomicity.

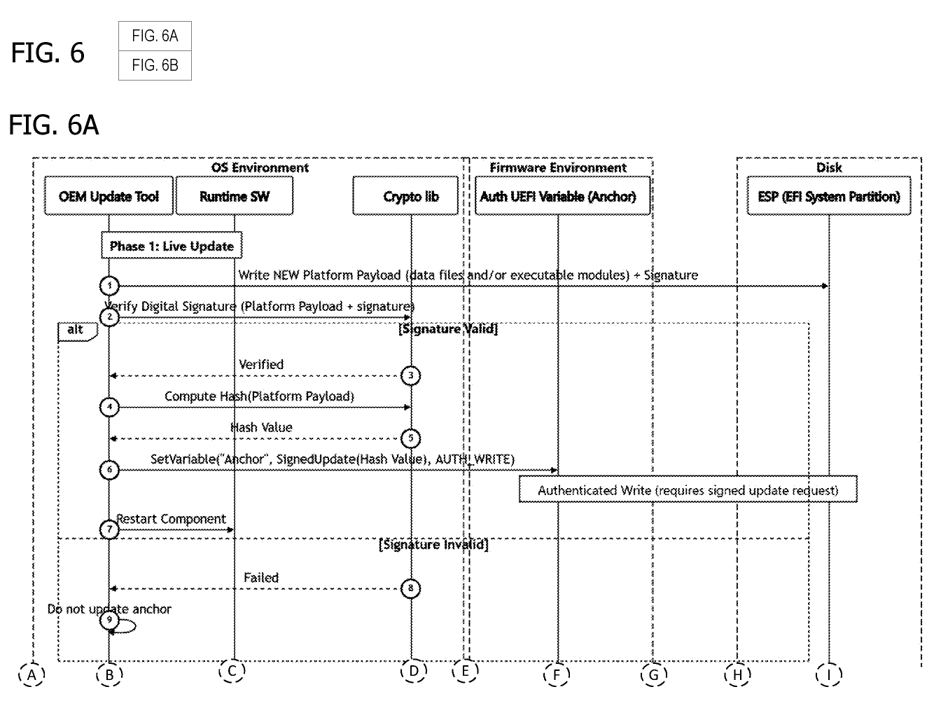

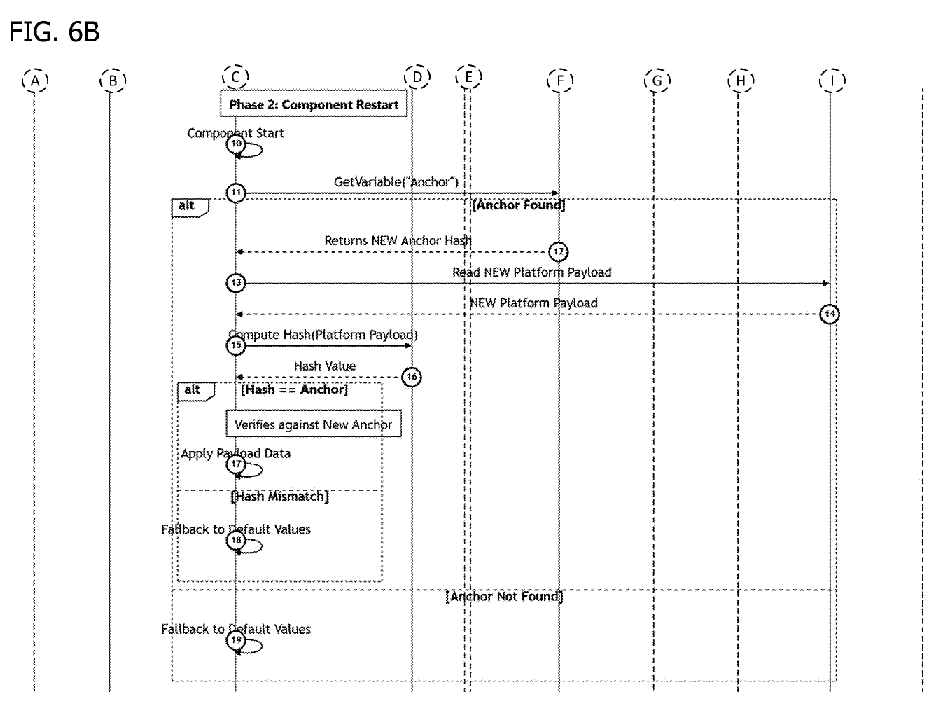

FIG. 6A and FIG. 6B together illustrate a sequence flow including a live update of the payload 221 stored in the non-volatile storage 212 that takes effect without requiring a reboot of the computing system. The sequence flow of FIG. 6 may involve an OEM update tool, a runtime software component, and a cryptographic library, which may be corresponding entities described in accordance with FIGS. 3, 4, and 5. The flow may further include the protected non-volatile storage 214 storing the authenticated UEFI variable store. The non-volatile storage 212 stores the EFI system partition. The sequence flow is divided into Phase 1, labelled "Live Update", illustrated in FIG. 6A, in which the OEM update tool performs the authenticated update of both the non-volatile storage 212 and the anchor value 241; and Phase 2, labelled "Component Restart", illustrated in FIG. 6B, in which the runtime software component 408 validates the replacement payload against the updated anchor value 241 after restarting.

Phase 1 of FIG. 6A may begin when the OEM update tool writes the replacement payload, which may include replacement data files and/or replacement executable modules, together with the corresponding replacement digital signature, to the EFI system partition. The OEM update tool can perform this write operation as a standard file system operation through operating system file system interfaces, without modifying the trusted storage 216 and without reflashing any firmware component. Following the write operation, the OEM update tool verifies the digital signature of the replacement payload using the cryptographic library, passing the replacement payload and the replacement digital signature as inputs before submitting the authenticated update request. The cryptographic library performs signature verification using the public key corresponding to the OEM signing key. This verification at the OS level is the trust-establishment step for the live-update path and is distinct from the boot-phase signature verification that the firmware 262 performs in the reboot-based path.

In an example, the OEM update tool, upon successful verification of the digital signature of the replacement payload by the cryptographic library, computes a cryptographic hash value of the replacement payload and submits an authenticated update request to the protected non-volatile storage 214 to update the anchor value 241. The authenticated update request to the protected non-volatile storage includes the computed cryptographic hash value of the replacement payload and optionally updated associated metadata. The authenticated update request does not include the replacement payload itself or the replacement digital signature, which are separately written to the unprotected non-volatile storage. The updated associated metadata may include one or more of an updated version identifier reflecting the version of the replacement payload, an updated hash algorithm identifier specifying the algorithm used to compute the cryptographic hash value, an updated key identifier identifying the trusted public key corresponding to the successful signature verification, an updated timestamp recording the time of the update, or other metadata fields that form part of the anchor value 241. The authenticated update request thereby enables the anchor value 241 to be refreshed during the runtime phase without requiring a reboot cycle and without requiring the firmware 262 to re-perform payload signature verification in that runtime path.

The OEM update tool submits the authenticated update request to the protected non-volatile storage 214 by invoking the SetVariable() UEFI runtime service, specifying the variable name and GUID identifying the anchor value 241, the AUTH_WRITE authenticated write attribute, and a signed update payload, shown in FIG. 6A as SetVariable("Anchor", SignedUpdate(Hash Value), AUTH_WRITE), as the variable data. The authenticated write attribute of the protected non-volatile storage 214 requires that the write operation be accompanied by a valid signed update payload before the protected non-volatile storage 214 accepts and commits the updated anchor value 241. The firmware 262 may enforce the authenticated write mechanism by validating the signature of the signed update payload before permitting the write to the protected non-volatile storage 214 to proceed, as indicated in FIG. 6A by the annotation "Authenticated Write (requires signed update request)”. As indicated in FIG. 6A, that authenticated write refreshes the anchor value only, while the replacement payload and the replacement digital signature remain on the non-volatile storage. If the signed update payload is valid, the protected non-volatile storage commits the updated anchor value, including the cryptographic hash value of the replacement payload and optionally the updated associated metadata.

Following the successful update of the anchor value 241 in the protected non-volatile storage 214, the OEM update tool may signal the runtime software component 408 to restart. The OEM update tool may restart the runtime software component 408 by sending a restart notification, by terminating and re-launching a driver or service process, or by invoking an operating system service management interface that stops and restarts the relevant service. The restart causes the runtime software component 408 to re-execute its start-up sequence, during which the runtime software component 408 can issue an access request to the payload 221 and perform hash-based validation against the updated anchor value 241. The restart of the runtime software component 408 does not require a reboot of the computing system and does not require any action by the firmware 262.

In the alternative branch of FIG. 6A in which the cryptographic library returns a Failed indication to the OEM update tool, indicating that the digital signature of the replacement payload is not valid, the OEM update tool does not compute a cryptographic hash value of the replacement payload and does not submit any authenticated update request to the protected non-volatile storage 214. The anchor value 241 in the protected non-volatile storage 214 remains unchanged and continues to reflect the cryptographic hash value of the previously verified payload 221. The OEM update tool does not restart the runtime software component 408. The replacement payload and its replacement digital signature remain on the non-volatile storage 212 as written. On the next boot phase of the computing system, the firmware 262 can detect a mismatch between the third cryptographic hash value of the payload computed during the fast path attempt and the first cryptographic hash value included by the existing anchor value 241, and can proceed to digital signature verification as described with reference to FIG. 5.

Phase 2 of FIG. 6B can begin when the runtime software component executes its Component Start sequence following the restart triggered by the OEM update tool. The runtime software component 408 issues a GetVariable call directed to the authenticated UEFI variable store, specifying the variable name and GUID of the anchor value 241. In the first alternative branch of FIG. 6B, labelled "Anchor Found", the authenticated UEFI variable store returns the new anchor hash to the runtime software component 408, reflecting the anchor value 241 updated by the OEM update tool during Phase 1. The runtime software component 408 issues a read request to the EFI system partition for the replacement payload. The EFI system partition returns the replacement payload to the runtime software component. The runtime software component invokes the cryptographic library to compute a hash value over the replacement payload and receives the computed hash value. In the sub-branch labelled "Hash == Anchor", the hash value matches the new anchor hash, the annotation "Verifies against New Anchor" confirms that the validation succeeds against the updated anchor value 241, and the runtime software component 408 applies the payload data. In the sub-branch labelled "Hash Mismatch", the runtime software component 408 falls back to default values. In the second alternative branch of FIG. 6B, labelled "Anchor Not Found", the runtime software component 408 falls back to default values without reading the replacement payload.

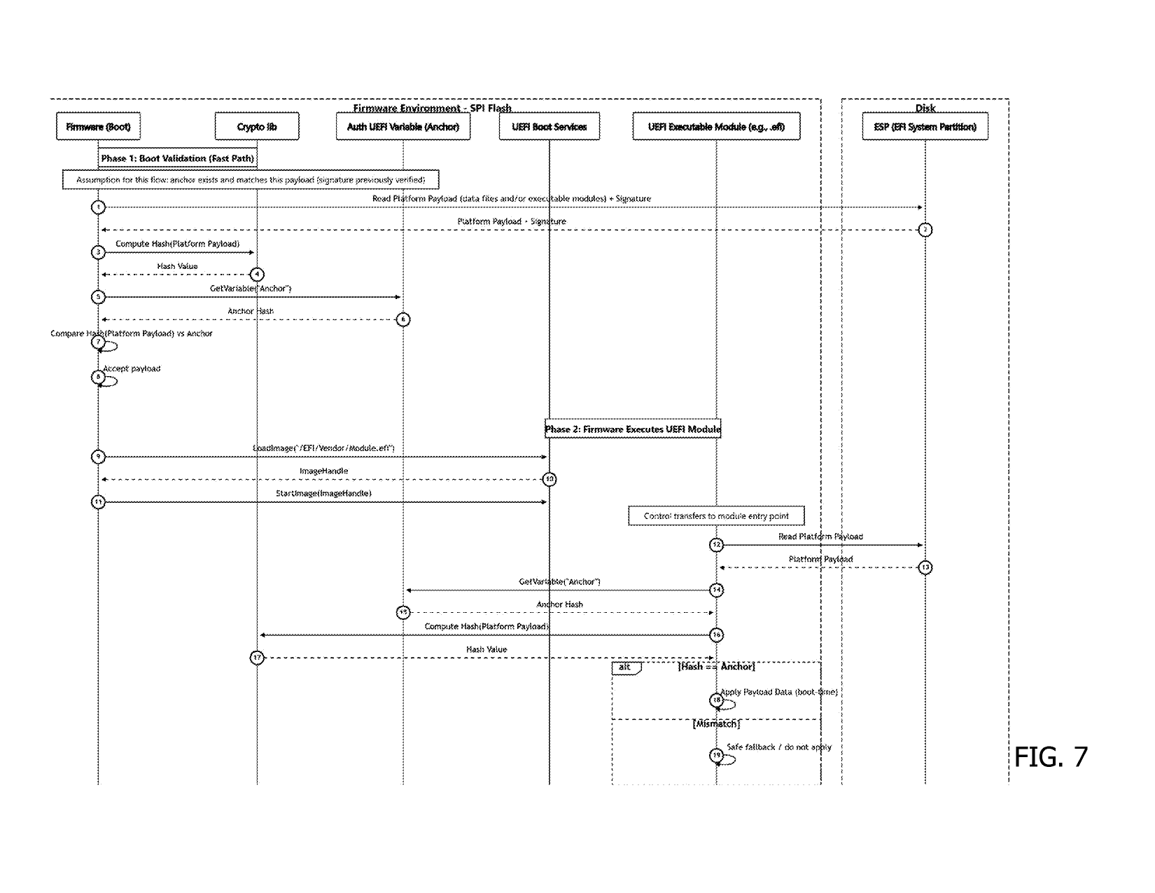

FIG. 7 illustrates a sequence flow for boot-time validation and execution of an executable firmware module included by the payload 221 stored in the non-volatile storage 212. The sequence flow of FIG. 7 may involve the firmware 262 executing from the trusted storage 216, the cryptographic library, the protected non-volatile storage 214 represented by the authenticated UEFI variable store, the UEFI Boot Services, a UEFI executable module representing the executable firmware module included by the payload 221, and the non-volatile storage 212 including the EFI system partition. The sequence flow is divided into Phase 1, labelled "Boot Validation (Fast Path)”, in which the firmware 262 validates the payload 221 against the anchor value 241, and Phase 2, labelled "Firmware Executes UEFI Module”, in which the firmware 262 loads and executes the validated executable module. The sequence flow carries the annotation "Assumption for this flow: anchor exists and matches this payload (signature previously verified”, establishing that the anchor value 241 is already present in the protected non-volatile storage 214 from a prior boot phase.

Phase 1 of FIG. 7 may begin when the firmware 262 issues a read request to the EFI system partition, requesting the payload 221 including both the data files and/or executable modules and the associated digital signature 222. The EFI system partition returns the payload 221 and the digital signature 222 to the firmware 262. The firmware 262 invokes the cryptographic library to compute a cryptographic hash value over the payload 221, passing the payload bytes over the defined byte domain as input. The cryptographic library returns the computed hash value to the firmware 262. The firmware 262 issues a GetVariable call directed to the authenticated UEFI variable store, specifying the variable name and GUID of the anchor value 241. The authenticated UEFI variable store returns the anchor hash included by the anchor value 241 to the firmware 262. The firmware 262 compares the computed cryptographic hash value of the payload 221 with the anchor hash. The firmware 262 accepts the payload 221 upon a match, as shown by the self-call labelled "Accept payload" in Phase 1 of FIG. 7.

In an example, the payload 221 stored in the non-volatile storage 212 includes an executable firmware module intended to be executed by the processor 202 during the boot phase. The executable firmware module may be a UEFI driver image, a UEFI application, or another UEFI executable module formatted as a Portable Executable image with a .efi file extension. The executable firmware module may provide hardware initialization, protocol installation, or platform configuration functions that the firmware 262 invokes during the boot phase. The non-volatile storage 212 may store the executable firmware module as part of a payload file that also includes associated configuration data, or as a standalone payload file including only the executable module bytes, in each case together with a digital signature 222 covering the defined byte domain of the payload 221.

In an example, upon successful validation of the payload 221 against the anchor value 241 during Phase 1, the firmware 262 loads the executable firmware module included by the payload 221 into volatile memory and executes the executable firmware module during the boot phase. Phase 2 of FIG. 7 shows the firmware 262 invoking the boot services image loading interface by issuing a LoadImage call directed to the UEFI Boot Services, specifying the path to the executable module on the EFI system partition, shown as LoadImage("/EFI/Vendor/Module.efi"). The UEFI Boot Services allocate volatile memory, copy the executable module image into the allocated memory, parse the Portable Executable header, and return an image handle to the firmware 262. The firmware 262 then invokes the boot services image execution interface by issuing a StartImage call directed to the UEFI Boot Services, passing the image handle as the sole argument. The UEFI Boot Services transfer control to the entry point of the executable module image, as indicated by the annotation "Control transfers to module entry point" in Phase 2 of FIG. 7.

In an example, the access request to the payload 221 is issued by the firmware 262 during the boot phase, with the firmware 262 acting as the consumer of the payload 221 prior to the LoadImage and StartImage operations of Phase 2. The firmware 262 reads the anchor value 241 from the protected non-volatile storage 214 and reads the payload 221 from the non-volatile storage 212 as part of the Phase 1 validation sequence. The firmware 262 computes a cryptographic hash value of the payload 221 and compares the computed cryptographic hash value with the first cryptographic hash value included by the anchor value 241. The firmware 262 accepts the payload 221 and proceeds to the LoadImage call only upon a match. The firmware 262 does not invoke LoadImage or StartImage if the payload 221 cannot be validated against the anchor value 241. The firmware 262 thereby acts as both the validator and the initial consumer of the payload 221 before transferring execution to the executable module via the UEFI Boot Services interfaces.

Following the StartImage call, the UEFI executable module executes with control at its entry point and performs a further validation of the payload 221 before applying any configuration data. The UEFI executable module issues a read request to the EFI system partition to read the payload 221. The EFI system partition returns the payload 221 to the UEFI executable module. The UEFI executable module issues a GetVariable call directed to the authenticated UEFI variable store to read the anchor value 241, specifying the same variable name and GUID used by the firmware 262 during Phase 1. The authenticated UEFI variable store returns the anchor hash to the UEFI executable module. The UEFI executable module invokes the cryptographic library to compute a hash value of the payload 221 and receives the computed hash value. The UEFI executable module thereby reads the anchor value 241 from the same protected non-volatile storage 214 and validates the payload 221 against the same anchor value 241 that the firmware 262 established during the boot phase.

In the first alternative of the comparison performed by the UEFI executable module, labelled "Hash == Anchor" in FIG. 7, the computed hash value matches the anchor hash and the UEFI executable module applies the payload data during the boot phase, as shown by the self-call labelled "Apply Payload Data (boot-time)“. The UEFI executable module may read platform configuration data from the payload 221 and apply the platform configuration data to configure a function of the computing system during the boot phase. In the second alternative, labelled "Mismatch" in FIG. 7, the UEFI executable module performs a safe fallback and does not apply any data from the payload 221, as shown by the self-call labelled "Safe fallback / do not apply“. The UEFI executable module may operate with predetermined default values or may decline to configure the relevant platform function.

In a deployment example, the OEM places a UEFI Wi-Fi driver image, formatted as a .efi executable, and a wireless regulatory parameter table on the non-volatile storage 212, accessible to the firmware 262 as files on the EFI system partition. The firmware 262 validates the payload 221 including the UEFI Wi-Fi driver image against the anchor value 241 in the protected non-volatile storage 214 during the boot phase and, upon a match, invokes LoadImage to load the UEFI Wi-Fi driver image into volatile memory and StartImage to execute the UEFI Wi-Fi driver image. The UEFI Wi-Fi driver, once executing, reads the wireless regulatory parameter table from the non-volatile storage 212, reads the anchor value 241 from the protected non-volatile storage 214 using GetVariable(), computes a cryptographic hash value of the regulatory parameter table, and applies the regulatory parameters, such as channel availability and transmit power limits for a specific country, only upon a hash match. A single firmware image may thereby support multiple computing platform product variants, each with its own UEFI driver image and associated regulatory data stored on the non-volatile storage 212, without requiring the firmware image to be updated when the platform-specific payload content changes.

The payload 221 stored in the non-volatile storage 212 may be stored as a file on the non-volatile storage 212. The file may include a header section, a data section, and a signature section. The header section occupies a fixed-size region at the beginning of the file and carries metadata fields identifying the structure and content of the payload 221. The data section may immediately follow the header section and contain the payload bytes constituting the platform-specific content of the payload 221. The signature section may be appended as a footer at the end of the file, following the data section. The signature section may carry the cryptographic artefacts associated with the digital signature 222 of the payload 221. The three-section file structure enables the firmware 262 and consumers of the payload 221 to locate each section at a deterministic offset without scanning, and enables the digital signature 222 to cover the defined byte domain of the payload 221 without covering the signature section itself.

The header section of the payload file may include at least one or a combination of the following fields. A Magic field carries a fixed byte sequence identifying the file as a payload file conforming to the format, enabling the firmware 262 and consumers to distinguish payload files from other files on the non-volatile storage 212. A FormatVersion field can identify the schema version of the file format, enabling the firmware 262 to detect and reject files whose format version is not supported. A PayloadVersion field may carry a monotonically increasing integer value assigned by the signing entity and representing the version of the payload 221, the same value that the firmware 262 may extract and store in the anchor value 241 as the version identifier. A PayloadSize field may carry the byte count of the data section, enabling the firmware 262 to determine the extent of the data section and to enforce configurable size limits before reading the data section into volatile memory.

The header section may further include algorithm identifier fields. For example, a hash algorithm identifier field, designated AlgoIds for hash, identifies the cryptographic hash algorithm that the signing entity applied when computing the cryptographic hash value over the payload file for the purpose of generating the digital signature 222. A signature algorithm identifier field, designated AlgoIds for signature, identifies the asymmetric signature algorithm that the signing entity applied when computing the digital signature 222. The header section further includes a PayloadType field identifying whether the data section contains configuration data, an executable firmware module, or a combination thereof. All fields of the header section may be encoded in little-endian byte order, and the total size of the header section is fixed and does not vary between payload file instances conforming to the same FormatVersion value.

The data section of the payload file may carry the opaque vendor bytes constituting the platform-specific content of the payload 221. The data section may contain configuration data such as wireless regulatory parameter tables, thermal management profiles, power delivery settings, security policy manifests, or display or sensor calibration tables. The data section may alternatively contain the binary image of an executable firmware module, such as a UEFI driver or application formatted as a Portable Executable image. The data section may contain a combination of configuration data and executable module bytes within the same payload file. The firmware 262 and consumers of the payload 221 treat the data section bytes as opaque and do not parse the internal structure of the data section for the purpose of integrity verification; the entire byte range of the data section is covered by both the cryptographic hash value and the digital signature 222 of the payload 221 without exception.

The signature section of the payload file may be appended as a footer following the data section and includes the following fields. A SigAlgoId field identifies the asymmetric signature algorithm used to compute the digital signature bytes carried in the section. A KeyId field in the signature section identifies which private key the signing entity used to compute the digital signature 222, enabling the firmware 262 to select the corresponding public key from a set of trusted public keys stored in the trusted storage 216. A SigLen field carries the byte count of the signature bytes that follow it within the signature section, enabling the firmware 262 to locate and read the signature bytes without relying on file-end detection. The signature section may carry signature bytes computed under more than one signature algorithm, with each set of signature bytes preceded by its own SigAlgoId and SigLen fields, enabling staged migration between signature algorithms. The signature section may not be covered by the cryptographic hash value that the firmware 262 computes over the payload file and that the firmware 262 stores as part of the anchor value 241.

In an example, the payload 221 may be stored on the non-volatile storage 212 as a file including the header section, the data section, and the signature section as described above, and the first cryptographic hash value stored as the anchor value 241 in the protected non-volatile storage 214 is computed over the header section and the data section of the file. The cryptographic hash function may be applied to the contiguous byte range beginning at the first byte of the header section and ending at the last byte of the data section; the signature section bytes are excluded from this hash domain. The firmware 262 and each consumer of the payload 221 can apply the cryptographic hash function over the same byte domain, i.e., the header section and the data section, in order to reproduce the same cryptographic hash value that the firmware 262 computed and stored as the anchor value 241. Any deviation in the hash domain, such as the inclusion of signature section bytes or the exclusion of header section bytes, produces a different hash value and results in a false mismatch during validation.

In some examples, the PayloadSize field in the header section may define the exact byte count of the data section, and the firmware 262 and consumers may be required to use the PayloadSize field to determine the end of the data section and therefore the boundary of the hash domain. The firmware 262 may validate the PayloadSize field against configurable platform policy thresholds before reading the data section into volatile memory, to prevent resource exhaustion from malformed or oversized payload files. The firmware 262 and consumers treat the bytes of the signature section as outside the hash domain and do not include those bytes in the input to the cryptographic hash function. The hash domain can therefore be fully deterministic given the PayloadSize field, the fixed size of the header section for the applicable FormatVersion, and the file layout specified above.

The anchor value 241 stored in the protected non-volatile storage 214 may be a composite record including a mandatory field set and an optional field set. The mandatory field set includes at minimum the first cryptographic hash value of the payload 221 and may also include the format version of the anchor value record itself. The anchor value 241 may be stored in the protected non-volatile storage 214 as a UEFI authenticated variable with the EFI_VARIABLE_NON_VOLATILE, EFI_VARIABLE_BOOTSERVICE_ACCESS, EFI_VARIABLE_RUNTIME_ACCESS, and EFI_VARIABLE_TIME_BASED_AUTHENTICATED_WRITE_ACCESS attributes. The anchor value 241 can be encoded in little-endian byte order. The first field of the anchor value record, at byte offset 0x00 and occupying one byte, is the FormatVersion field, which carries the schema version of the anchor value record structure and enables the firmware 262 and consumers to detect and reject anchor value records whose schema version is not supported by the current firmware 262 or runtime software component 408.

The anchor value 241 may include a PrimaryHash field, beginning at byte offset 0x10, which carries the first cryptographic hash value of the payload 221. The PrimaryHash field may be 32 bytes when the hash algorithm applied is SHA-256 and 48 bytes when the hash algorithm applied is SHA-384. The firmware 262 writes the first cryptographic hash value into the PrimaryHash field during the SetVariable operation that creates or updates the anchor value 241 in the protected non-volatile storage 214. The runtime software component may read the PrimaryHash field from the anchor value 241 via the GetVariable() runtime service and uses the value as the reference against which the second cryptographic hash value, computed over the payload 221 currently held on the non-volatile storage 212, is compared. The PrimaryHash field can constitute the cryptographic link between the non-volatile storage 212, which holds the untrusted payload 221, and the protected non-volatile storage 214, which holds the firmware-established integrity reference.

In an example, the anchor value 241 includes a hash algorithm identifier stored at byte offset 0x01, occupying one byte, in the field designated HashAlgoId. The HashAlgoId field carries an enumerated value identifying the cryptographic hash algorithm used to compute the first cryptographic hash value stored in the PrimaryHash field. For example, a HashAlgoId value of 0x00 identifies SHA-256, producing a 32-byte PrimaryHash field. A HashAlgoId value of 0x01 identifies SHA-384, producing a 48-byte PrimaryHash field. The firmware 262 writes the HashAlgoId value corresponding to the algorithm used during signature verification into the anchor value 241 when performing the SetVariable operation. The runtime software component may read the HashAlgoId field from the anchor value 241 before computing the second cryptographic hash value, in order to apply the same hash algorithm as the firmware 262 and produce a result that is comparable to the PrimaryHash field.

In an example, the anchor value 241 includes a version identifier stored at byte offset 0x04, occupying four bytes, in the field designated PayloadVersion, encoded as a little-endian unsigned 32-bit integer. The firmware 262 extracts the PayloadVersion value from the PayloadVersion field of the payload file header and stores the extracted value in the PayloadVersion field of the anchor value 241 during the SetVariable operation. The PayloadVersion value is monotonically increasing, meaning that successive payload versions produced by the signing entity carry strictly non-decreasing PayloadVersion values. When the firmware 262 determines that the anchor value 241 is already present in the protected non-volatile storage 214 and computes a mismatch indicating that the payload 221 has been replaced, the firmware 262 may extract the PayloadVersion value from the replacement payload file header and compare the extracted value with the PayloadVersion value included by the existing anchor value 241. The firmware 262 may decline to update the anchor value 241 if the extracted PayloadVersion value is lower than the PayloadVersion value included by the existing anchor value 241, notwithstanding that the digital signature of the replacement payload is valid.

In an example, the anchor value 241 includes a key identifier stored at byte offset 0x03, occupying one byte, in the field designated KeyId. The KeyId field identifies which trusted public key, from among a set of trusted public keys stored in the trusted storage 216 or otherwise provisioned for authorized verification of the payload 221, corresponded to the most recent successful signature verification on which the anchor value 241 is based. The firmware 262 or the authorized update process writes the KeyId value corresponding to the public key used during that verification into the KeyId field of the anchor value 241 during the SetVariable operation. In an example, the anchor value 241 includes a timestamp stored at byte offset 0x08, occupying eight bytes, in the field designated TimestampUtc, encoded as a UNIX epoch value representing the number of seconds elapsed since 00:00:00 UTC on 1 January 1970. The firmware 262 or the authorized update process may write the current platform time into the TimestampUtc field of the anchor value 241 when performing the SetVariable operation. The TimestampUtc field may be set to zero when the platform time is not available at the time the anchor value 241 is established.

In an example, the anchor value 241 may include a location identifier in the field designated LocationDesc, positioned at a variable byte offset following the PrimaryHash field or the NextHash field when the NextHash field is present. The LocationDesc field is a variable-length field carrying an advisory pointer to the payload 221 on the non-volatile storage 212, which may be a file system path on the EFI system partition, a GUID, or another identifier enabling the firmware 262 and consumers to locate the payload 221 without scanning the non-volatile storage 212. The LocationDesc field is advisory: the integrity of the payload 221 is enforced exclusively by the PrimaryHash field of the anchor value 241, not by the LocationDesc field. The firmware 262 and consumers may use the LocationDesc field as a performance optimization when locating the payload 221 but must not treat the LocationDesc field as a security-critical control. In an example, the anchor value 241 may include a Flags field stored at byte offset 0x02, occupying one byte, whose individual bits indicate the presence of optional fields within the anchor value record, including a bit indicating that the NextHash field described below is present.

In an example, the anchor value 241 may include a second reference cryptographic hash value computed using a hash algorithm different from the hash algorithm identified by the HashAlgoId field. The second reference cryptographic hash value is stored in the field designated NextHash, which begins at byte offset 0x30 when the PrimaryHash field is 32 bytes and at byte offset 0x40 when the PrimaryHash field is 48 bytes, and occupies 32 or 48 bytes depending on the algorithm of the second reference cryptographic hash value. The NextHash field is present in the anchor value record only when the Flags field indicates its presence; when the Flags field does not indicate the presence of the NextHash field, the field occupies zero bytes. The NextHash field supports a staged algorithm migration scenario in which the signing entity and the firmware 262 pre-position a cryptographic hash value computed under a next-generation hash algorithm alongside the primary hash value computed under the current hash algorithm. During such a migration, the firmware 262 writes both the PrimaryHash value computed under the current algorithm and the NextHash value computed under the next-generation algorithm into the anchor value 241 during the same SetVariable operation. The firmware 262 and consumers may validate the payload 221 against either the PrimaryHash field or the NextHash field during the migration period, and may promote the NextHash value to become the new PrimaryHash value upon completion of the migration by issuing an authenticated update of the anchor value 241.

In various aspects, the lifecycle of the payload 221 may begin off-platform. The OEM or an authorized signing entity authors the payload 221, normalizes the payload 221 into the file format including a header section, a data section, and a signature section, and applies an asymmetric private key to compute the digital signature 222 over the header section and the data section. The signing entity distributes the signed payload file, including the payload 221 and the digital signature 222, through standard software distribution channels such as enterprise management tools, operating system update services, or provisioning pipelines, to the computing system. The distribution process does not require the signing entity to modify the trusted storage 216 or to reflash any firmware component. The signing entity retains the private key and does not distribute the private key to the computing system or to any update agent executing on the computing system. The computing system stores the corresponding public key as the cryptographic key 261 in the trusted storage 216, and the firmware 262 uses the cryptographic key 261 during the boot phase to verify the digital signature 222 of each payload 221 that the signing entity has distributed to the non-volatile storage 212.

An operating system process, such as an OEM update tool or a provisioning service, may write the signed payload file to the non-volatile storage 212, placing the payload 221 and the digital signature 222 at a defined path on the EFI system partition. The operating system process performs the write operation through standard file system interfaces without issuing any authenticated write to the protected non-volatile storage 214 and without modifying the anchor value 241 that the protected non-volatile storage 214 currently holds. The update workflow enforces a file-write-first ordering: the operating system process writes the payload 221 and the digital signature 222 to the non-volatile storage 212 before the firmware 262 or the operating system process updates the anchor value 241 in the protected non-volatile storage 214. Any intermediate state arising after the operating system process completes the write to the non-volatile storage 212 but before the firmware 262 or the operating system process updates the anchor value 241 causes the firmware 262 or a consuming component to detect a hash mismatch during subsequent validation, rather than silently accepting the updated payload 221 as trusted.

In an example, the operating system process updates the payload 221 stored in the non-volatile storage 212 by writing a replacement payload and a replacement digital signature to the non-volatile storage 212 without reflashing the firmware 262, and the firmware 262 updates the anchor value 241 in the protected non-volatile storage 214 at the next boot phase. During the next boot phase, the firmware 262 reads the existing anchor value 241 from the protected non-volatile storage 214, reads the replacement payload from the non-volatile storage 212, and computes a third cryptographic hash value over the replacement payload. The firmware 262 compares the third cryptographic hash value with the first cryptographic hash value that the existing anchor value 241 includes. Upon detecting a mismatch, the firmware 262 verifies the digital signature of the replacement payload using the cryptographic key 261 stored in the trusted storage 216. Upon successful verification, the firmware 262 computes an updated cryptographic hash value over the replacement payload and stores the updated cryptographic hash value in the protected non-volatile storage 214 as the updated anchor value 241 via an authenticated write operation, replacing the prior first cryptographic hash value. Upon failed verification, the firmware 262 deletes the existing anchor value 241 from the protected non-volatile storage 214.

In an example, an operating system process submits an authenticated update request to update the anchor value 241 in the protected non-volatile storage 214 during the runtime phase without requiring a reboot cycle. In that runtime path, the operating system process separately writes a replacement payload and a replacement digital signature of the replacement payload to the non-volatile storage 212, verifies the replacement digital signature against the replacement payload, computes a cryptographic hash value of the verified replacement payload, and submits the authenticated update request carrying the computed cryptographic hash value and optionally updated associated metadata. The optionally updated associated metadata may include one or more of an updated version identifier reflecting the version of the replacement payload, an updated hash algorithm identifier specifying the algorithm applied to compute the cryptographic hash value, an updated key identifier identifying the trusted public key corresponding to the successful signature verification, and an updated timestamp recording the time of the update. The firmware 262 accepts the authenticated update request and updates the anchor value 241 in the protected non-volatile storage 214 only when the authenticated update request carries a valid cryptographic authorization artefact. Following the update of the anchor value 241 through either the reboot-based path or the runtime authenticated update path, each consumer of the payload 221 reads the anchor value 241 from the protected non-volatile storage 214, reads the payload 221 from the non-volatile storage 212, computes a second cryptographic hash value, and compares the second cryptographic hash value with the first cryptographic hash value that the anchor value 241 includes before applying or executing the payload 221.

In an example, the non-volatile storage 212 stores a plurality of payloads, each payload including a respective digital signature, and the protected non-volatile storage 214 stores a respective first cryptographic hash value for each payload of the plurality. The firmware 262 verifies the digital signature of each payload of the plurality independently during the boot phase and stores a respective anchor value 241 in the protected non-volatile storage 214 for each payload, identifying each respective anchor value 241 by a distinct GUID and variable name combination. Each consumer of a payload of the plurality reads the respective anchor value 241 from the protected non-volatile storage 214 by issuing a GetVariable call specifying the GUID and variable name identifying the respective anchor value 241, reads the respective payload from the non-volatile storage 212, computes a respective second cryptographic hash value over the respective payload, and compares the respective second cryptographic hash value with the respective first cryptographic hash value that the respective anchor value 241 includes before applying or executing the respective payload. The firmware 262 treats each payload of the plurality as an independent unit of integrity, such that the firmware 262 can verify, update, or delete the anchor value 241 for one payload without modifying the anchor values 241 that the firmware 262 associates with any other payload of the plurality.

In a concrete deployment example, a single firmware image stored in the trusted storage 216 supports multiple computing platform product variants, each requiring a distinct payload 221 on the non-volatile storage 212. The non-volatile storage 212 may carry a respective wireless network driver image and a corresponding wireless regulatory parameter table for each of several regional or product-specific variants, each constituting a distinct payload 221 with its own digital signature 222 and its own anchor value 241 in the protected non-volatile storage 214. The firmware 262 verifies and establishes an anchor value 241 for each payload 221 independently during the boot phase, without requiring a distinct firmware image per product variant. The OEM may update the payload 221 for any one product variant by writing a replacement payload and replacement digital signature to the non-volatile storage 212 for that variant, without modifying the payloads 221 that the non-volatile storage 212 holds for other variants. Each runtime software component 408 reads the respective anchor value 241 for the payload 221 that the runtime software component 408 consumes, computes a cryptographic hash value, and validates the payload 221 against the respective anchor value 241 before applying the configuration data or executing the executable module.

In an example, the computing system may store a plurality of payloads on the non-volatile storage 212 using a Merkle root aggregation approach, in which the firmware 262 stores a single root hash value as the anchor value 241 in the protected non-volatile storage 214 rather than a respective anchor value 241 per payload. The firmware 262 hashes each payload of the plurality to produce a per-payload leaf hash value, constructs a hash tree by iteratively applying a cryptographic hash function to pairs of adjacent values starting from the leaf hash values and proceeding toward the root, and stores the resulting root hash value as the anchor value 241 in the protected non-volatile storage 214 via an authenticated write operation. A consumer of a specific payload of the plurality validates the specific payload by computing the leaf hash value for the specific payload and verifying the computed leaf hash value against the root hash value stored in the anchor value 241, using an authenticated path of intermediate hash values through the tree. The Merkle root approach allows the firmware 262 to maintain a single anchor value 241 in the protected non-volatile storage 214 for an arbitrarily large set of payload files on the non-volatile storage 212.

When an adversary modifies one or more bytes of the payload 221 on the non-volatile storage 212 after the firmware 262 has established the anchor value 241, the firmware 262 or the consuming component that next validates the payload 221 computes a cryptographic hash value over the modified bytes and produces a value that differs from the first cryptographic hash value stored in the anchor value 241. The firmware 262 or the consuming component detects the mismatch, rejects the modified payload 221 without applying any data from the modified payload 221, and falls back to predetermined default values. The computing system does not require the consuming component to hold the cryptographic key 261 or any asymmetric key material to detect tampering: the consuming component reads the anchor value 241 from the protected non-volatile storage 214 and uses the first cryptographic hash value that the anchor value 241 includes as the sole integrity reference. The tamper-detection mechanism applies equally to payloads 221 including configuration data and to payloads 221 including executable firmware modules: any byte-level modification of the payload 221 on the non-volatile storage 212, whether intentional or accidental, causes the firmware 262 or the consuming component to reject the payload 221.

The protected non-volatile storage 214 rejects any write to the anchor value 241 that does not carry a valid cryptographic authorization artefact, preventing an adversary who controls the operating system 223 from publishing a forged anchor value 241 that would cause consuming components to accept a malicious payload. When the trusted storage 216 includes firmware storage such as a SPI flash device, hardware write-protection mechanisms on the firmware storage prevent the operating system 223 and any software the processor 202 executes during the runtime phase from modifying the cryptographic key 261, and the firmware 262 uses the write-protected cryptographic key 261 to enforce the authenticated write access mechanism for the anchor value 241. When the trusted storage 216 includes a trusted platform module (TPM), the TPM provides a dedicated hardware component whose key storage and cryptographic operations execute in an environment isolated from the processor 202 and the operating system 223, and the firmware 262 may delegate cryptographic authorization verification for authenticated writes to the TPM. When the trusted storage 216 includes a secure element, the secure element provides a tamper-resistant hardware module from which the operating system 223 and runtime software cannot extract the stored key material, and the firmware 262 may use the secure element to perform the verification of the cryptographic authorization artefact accompanying each write to the anchor value 241.

In an example, the firmware 262 enforces an anti-rollback policy using the version identifier that the anchor value 241 stores at byte offset 0x04. When the firmware 262 successfully verifies the digital signature of a replacement payload after detecting a hash mismatch, the firmware 262 extracts the version identifier from the PayloadVersion field of the replacement payload file header and compares the extracted version identifier with the version identifier that the existing anchor value 241 includes. The firmware 262 declines to update the anchor value 241 and does not write any updated hash value to the protected non-volatile storage 214 if the extracted version identifier is numerically lower than the version identifier that the existing anchor value 241 includes, even when the digital signature of the replacement payload is valid. As a concrete example, when a regulatory authority issues a revised specification of the permitted wireless radio frequency parameters for a given country and the OEM distributes an updated payload 221 carrying a higher version identifier than the currently deployed payload, the firmware 262 subsequently refuses to accept any payload carrying a lower version identifier, ensuring that the computing system continues to apply the current regulatory parameters and does not revert to a superseded version.

The firmware 262 or the runtime software component 408 mitigates time-of-check-to-time-of-use risks by executing the validation sequence — reading the anchor value 241 from the protected non-volatile storage 214, reading the payload 221 from the non-volatile storage 212, computing the second cryptographic hash value, performing the constant-time comparison, and applying or rejecting the payload 221 — as a continuous, uninterrupted sequence immediately before the firmware 262 or the runtime software component 408 applies or executes the payload 221. In various embodiments, the firmware 262 or the runtime software component 408 may be configured such that it does not introduce any delay or yield point between completing the comparison and consuming the payload 221, and validates the exact bytes that the firmware 262 or the runtime software component 408 subsequently applies, thereby reducing the interval within which an adversary might substitute the payload 221 on the non-volatile storage 212 between validation and use. The firmware 262 validates the payload 221 against the anchor value 241 immediately before issuing the LoadImage call for an executable module, ensuring that the bytes the UEFI Boot Services load into volatile memory match the bytes that the firmware 262 compared against the anchor value 241. The file-write-first update ordering ensures that a power loss between an operating system write and a subsequent anchor value update causes the firmware 262 to detect a mismatch and perform digital signature verification on the next boot, rather than silently accepting the partially updated state.

When the firmware 262 or a consuming component rejects the payload 221 due to a hash mismatch, a missing anchor value 241, or a failed digital signature verification, the firmware 262 or the consuming component applies predetermined default values and the computing system continues to operate, providing platform services that do not depend on the rejected payload 221. The firmware 262 may emit a telemetry event or write a log entry when rejecting the payload 221 or deleting the anchor value 241, enabling platform management software to detect the condition. The architecture presents the following residual risks: an adversary who compromises the OEM signing private key may produce a replacement payload 221 with a valid digital signature and cause the firmware 262 to accept and anchor the malicious payload; an adversary with operating system-level access to the non-volatile storage 212 may delete the payload file, causing the firmware 262 and consuming components to fall back for all functions that depend on the payload 221, and platform management software may detect the absent payload file and alert the user; and an adversary may present an oversized payload file to exhaust the volatile memory or processing resources that the firmware 262 allocates during the boot phase. The firmware 262 may enforce a maximum payload file size threshold and may reject any payload file whose PayloadSize field exceeds the configured threshold.

In an example, the firmware 262 may apply segment-level hashing to a large payload 221 that consuming components access in portions. The firmware 262 divides the payload 221 into contiguous segments, computes a hash value for each segment, and stores the per-segment hash values as an authenticated structure in the protected non-volatile storage 214. A consuming component that accesses only a subset of the payload data validates only the segments that the consuming component reads, using the per-segment hash values from the protected non-volatile storage 214 as references. In an example, the firmware 262 may apply a policy overlay approach in which a base payload and a signed overlay together constitute the logical payload 221: the firmware 262 combines the base payload and the overlay deterministically before computing the cryptographic hash value, and the hash covers the combined content rather than either component separately. In an example, the anchor value 241 stored in the protected non-volatile storage 214 may include a second reference cryptographic hash value computed using a hash algorithm different from the algorithm that the HashAlgoId field identifies, stored in the NextHash field of the anchor value record, enabling the firmware 262 to migrate from a current hash algorithm to a next-generation algorithm in a staged transition. During the migration period, the firmware 262 stores both the primary hash value in the PrimaryHash field and the second reference hash value in the NextHash field within the same anchor value 241, and the Flags field at byte offset 0x02 indicates the presence of the NextHash field.

In an example, the firmware 262 may support signing key rotation by maintaining a set of trusted public keys in the trusted storage 216, each identifiable by a distinct key identifier, and using the KeyId field of the anchor value 241 at byte offset 0x03 to record which trusted public key corresponded to the most recent successful signature verification on which the anchor value 241 is based. When the OEM rotates the signing key, the OEM distributes a replacement payload 221 that the OEM signed with the new private key, and the firmware 262 or an authorized update process reads the key identifier from the KeyId field of the replacement payload signature section, selects the corresponding trusted public key, and verifies the replacement digital signature using that key. The firmware 262 may maintain a multi-key policy that specifies which key identifiers the firmware 262 currently trusts and may refuse to verify digital signatures using a key identifier that the OEM has retired. In an example, the protected non-volatile storage 214 may take the form of a hardware security module or firmware read-only storage rather than a UEFI authenticated variable store, provided that the alternative implementation enforces an authenticated write access mechanism requiring a cryptographic authorization artefact accompanying each write to the anchor value 241. The runtime software component 408 may read the anchor value 241 from an alternative protected non-volatile storage implementation through an ACPI method that the firmware 262 exposes in the ACPI namespace, callable by the runtime software component 408 through the operating system's ACPI subsystem.

In an example, the firmware 262 may verify the digital signature 222 of the payload 221 on every boot phase without first computing a third cryptographic hash value for comparison with the existing anchor value 241, regardless of whether the anchor value 241 is already present in the protected non-volatile storage 214. The firmware 262 proceeds directly to digital signature verification on each boot phase, and upon successful verification, computes a cryptographic hash value over the payload 221 and stores the cryptographic hash value as the updated anchor value 241 in the protected non-volatile storage 214 via an authenticated write operation. In an example, a validated payload 221 including an executable module may support execution by a runtime software component 408 executing under the operating system 223, rather than by the firmware 262 during the boot phase: the runtime software component 408 reads the payload 221 from the non-volatile storage 212, validates the payload 221 against the anchor value 241 in the protected non-volatile storage 214, and, upon successful validation, executes the validated executable module using operating system execution interfaces. The non-volatile storage 212 may store any number of payload files that the capacity of the non-volatile storage 212 accommodates, with the firmware 262 maintaining either a per-payload anchor value 241 in the protected non-volatile storage 214 for each payload file individually or a single Merkle root hash value as the anchor value 241 for all payload files collectively, enabling the architecture to scale to deployment scenarios that require many distinct payloads on a single computing platform.

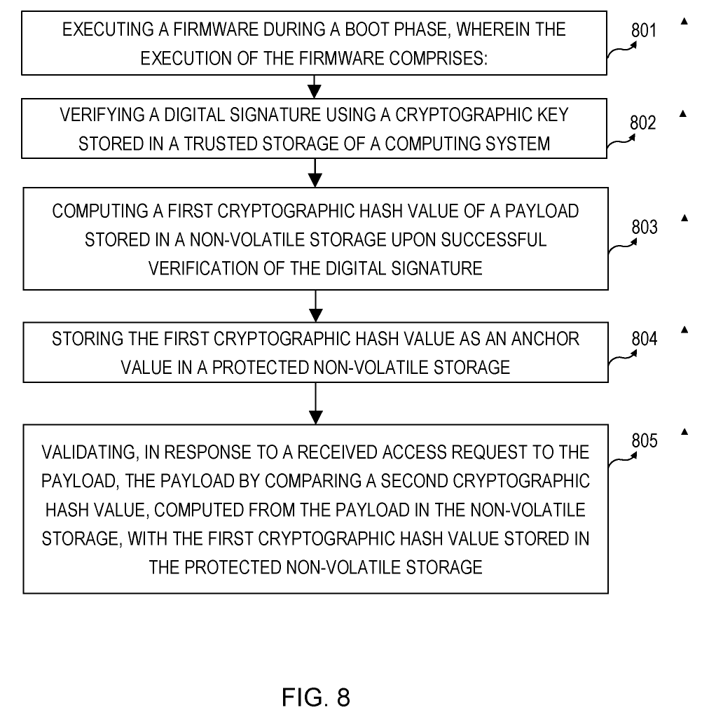

FIG. 8 shows an example of a method. The method may include executing 801 a firmware during a boot phase, wherein the execution of the firmware includes: verifying 802 a digital signature using a cryptographic key stored in a trusted storage of a computing system; computing 803 a first cryptographic hash value of a payload stored in a non-volatile storage upon successful verification of the digital signature; and storing 804 the first cryptographic hash value as an anchor value in a protected non-volatile storage, wherein the method further includes validating 805, in response to a received access request to the payload, the payload by comparing a second cryptographic hash value, computed from the payload in the non-volatile storage, with the first cryptographic hash value stored in the protected non-volatile storage.

The detailed description refers to the accompanying drawings that show, by way of illustration, specific details and aspects of this disclosure in which the disclosure may be practiced. Other aspects may be utilized and structural, logical, and electrical changes may be made without departing from the scope of the disclosure. The various aspects of this disclosure are not necessarily mutually exclusive, as some aspects of this disclosure can be combined with one or more other aspects of this disclosure to form new aspects.

Throughout the drawings, it should be noted that like reference numbers are used to depict the same or similar elements, features, and structures, unless otherwise noted.

The word "exemplary" is used herein to mean "serving as an example, instance, or illustration". Any aspect or design described herein as "exemplary" is not necessarily to be construed as preferred or advantageous over other aspects or designs.

The phrase “at least one” and “one or more” may be understood to include a numerical quantity greater than or equal to one (e.g., one, two, three, four, […], etc.). The phrase "at least one of" with regard to a group of elements may be used herein to mean at least one element from the group consisting of the elements. For example, the phrase "at least one of" with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, […], etc.).

The phrases “group (of)”, “set (of)”, “collection (of)”, “series (of)”, “sequence (of)”, “grouping (of)”, etc., in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

Further, spatially relative terms, such as "beneath," "below," "lower," "above," "upper" and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

As utilized herein, terms "module", "component," "system," "circuit," "element," "slice," "circuitry," and the like are intended to refer to a set of one or more electronic components, a computer-related entity, hardware, software (e.g., in execution), and/or firmware. For example, circuitry or a similar term can be a processor, a process running on a processor, a controller, an object, an executable program, a storage device, and/or a computer with a processing device. By way of illustration, an application running on a server and the server can also be circuitry. One or more circuits can reside within the same circuitry, and circuitry can be localized on one computer and/or distributed between two or more computers. A set of elements or a set of other circuits can be described herein, in which the term "set" can be interpreted as "one or more".

It will be understood that when an element is referred to as being "connected" or "coupled" to another element, it can be physically connected or coupled to the other element such that current and/or electromagnetic radiation (e.g., a signal) can flow along a conductive path formed by the elements. Intervening conductive, inductive, or capacitive elements may be present between the element and the other element when the elements are described as being coupled or connected to one another. Further, when coupled or connected to one another, one element may be capable of inducing a voltage or current flow or propagation of an electro-magnetic wave in the other element without physical contact or intervening components. Further, when a voltage, current, or signal is referred to as being "applied" to an element, the voltage, current, or signal may be conducted to the element by way of a physical connection or by way of capacitive, electro-magnetic, or inductive coupling that does not involve a physical connection.

The following examples pertain to further aspects of this disclosure.

Example 1 includes the subject matter of a computing system. The subject matter including: a non-volatile storage configured to store a payload and a digital signature of the payload; a protected non-volatile storage; a trusted storage configured to store a cryptographic key; a processor configured to: execute a firmware during a boot phase, wherein the firmware is configured to cause the processor to: verify the digital signature using the cryptographic key stored in the trusted storage of the computing system; compute a first cryptographic hash value of the payload upon successful verification of the digital signature; and store the first cryptographic hash value as an anchor value in the protected non-volatile storage, wherein the processor is further configured to validate, in response to a received access request to the payload, the payload by comparing a second cryptographic hash value, computed from the payload in the non-volatile storage, with the first cryptographic hash value stored in the protected non-volatile storage.

Example 2 may include the subject matter of example 1, wherein the trusted storage includes at least one of firmware storage, a trusted platform module (TPM), or a secure element, configured to store the firmware; and wherein the protected non-volatile storage is protected by an authenticated write access mechanism, and the protected non-volatile storage is further configured to store authenticated variables for the firmware.

Example 3 may include the subject matter of any one of examples 1 to 2, wherein the non-volatile storage includes a partition on a disk storage device, the partition being accessible to the firmware during the boot phase and accessible to an operating system during a runtime phase.

Example 4 may include the subject matter of example 3, wherein the partition is an extensible firmware interface, EFI, or a unified EFI (UEFI) system partition.

Example 5 may include the subject matter of any one of examples 1 to 4, wherein the firmware is configured to cause the processor to extract a version identifier from the payload and store the version identifier in the protected non-volatile storage together with the first cryptographic hash value as the anchor value.

Example 6 may include the subject matter of any one of examples 1 to 5, wherein the firmware is configured to cause the processor to determine whether an anchor value is present in the protected non-volatile storage before verifying the digital signature, and wherein the processor is further configured to use the anchor value to validate the payload.

Example 7 may include the subject matter of example 6, wherein the firmware is configured to cause the processor to, during a subsequent boot phase: compute a third cryptographic hash value of the payload in the non-volatile storage; compare the third cryptographic hash value with the first cryptographic hash value stored in the protected non-volatile storage; and upon a match, accept the payload without verifying the digital signature.

Example 8 may include the subject matter of example 7, wherein the firmware is configured to cause the processor to, upon a mismatch between the third cryptographic hash value and the first cryptographic hash value: verify the digital signature of the payload; upon successful verification, compute an updated cryptographic hash value of the payload; and replace the first cryptographic hash value stored as the anchor value in the protected non-volatile storage with the updated cryptographic hash value.

Example 9 may include the subject matter of any one of examples 1 to 8, wherein the payload includes platform configuration data, and wherein the processor is configured to, upon successful validation, apply the platform configuration data to configure a function of the computing system during the boot phase.

Example 10 may include the subject matter of any one of examples 1 to 9, wherein the payload includes an executable firmware module.

Example 11 may include the subject matter of example 10, wherein the firmware is configured to cause the processor to load and execute the executable firmware module during the boot phase upon successful validation.

Example 12 may include the subject matter of example 11, wherein the processor is further configured to invoke a boot services image loading interface and a boot services image execution interface to load and execute the executable firmware module.

Example 13 may include the subject matter of any one of examples 1 to 12, wherein the access request is received from a runtime software component being executed by the processor after the boot phase, and wherein the runtime software component reads the anchor value from the protected non-volatile storage via a runtime variable access interface, preferably wherein the anchor value is read via a runtime access interface including at least one of a UEFI variable access interface, an ACPI method, or a firmware-to-operating-system communication interface, and preferably wherein the runtime software component is configured to validate the payload.

Example 14 may include the subject matter of any one of examples 1 to 12, wherein the access request is received from the firmware during the boot phase.

Example 15 may include the subject matter of any one of examples 1 to 14, wherein the first cryptographic hash value is stored in the protected non-volatile storage together with a hash algorithm identifier.

Example 16 may include the subject matter of example 15, wherein the protected non-volatile storage is further configured to store a reference cryptographic hash value computed using a hash algorithm different from that identified by the hash algorithm identifier.

Example 17 may include the subject matter of any one of examples 1 to 16, wherein the first cryptographic hash value is stored in the protected non-volatile storage together with a key identifier identifying the cryptographic key used to verify the digital signature.

Example 18 may include the subject matter of any one of examples 1 to 17, wherein the protected non-volatile storage is further configured to store a location identifier associated with the payload in the non-volatile storage.

Example 19 may include the subject matter of any one of examples 1 to 18, wherein the first cryptographic hash value is stored in the protected non-volatile storage together with a timestamp.

Example 20 may include the subject matter of any one of examples 1 to 19, wherein the non-volatile storage stores the payload as a file including a header, a data section, and a signature section, and wherein the first cryptographic hash value is computed over the header and the data section.

Example 21 may include the subject matter of any one of examples 1 to 20, wherein the non-volatile storage is configured to store a plurality of payloads, each associated with a respective digital signature, and wherein the protected non-volatile storage is configured to store a respective cryptographic hash value for each of the plurality of payloads.

Example 22 may include the subject matter of any one of examples 1 to 21, wherein the processor is configured to update the anchor value in the protected non-volatile storage in response to an authenticated update request received from an operating system process, wherein the operating system process separately writes a replacement payload and a replacement digital signature to the non-volatile storage, and the authenticated update request to the protected non-volatile storage includes a computed cryptographic hash value of the replacement payload and optionally updated associated metadata.

Example 23 may include the subject matter of any one of examples 1 to 22, wherein a replacement payload and a replacement digital signature are deployed to the non-volatile storage by an operating system process, and wherein the firmware is configured to verify the replacement digital signature and update the first cryptographic hash value in the protected non-volatile storage during a subsequent boot phase, wherein preferably the firmware is further configured to, upon a mismatch between a cryptographic hash value computed over the replacement payload and the first cryptographic hash value included by the anchor value, perform the verification and update.

Example 24 may include the subject matter of a method. The subject matter may include: executing a firmware during a boot phase, wherein the execution of the firmware includes: verifying a digital signature using a cryptographic key stored in a trusted storage of a computing system; computing a first cryptographic hash value of a payload stored in a non-volatile storage upon successful verification of the digital signature; and storing the first cryptographic hash value as an anchor value in a protected non-volatile storage, wherein the method further includes validating, in response to a received access request to the payload, the payload by comparing a second cryptographic hash value, computed from the payload in the non-volatile storage, with the first cryptographic hash value stored in the protected non-volatile storage.

Example 25 may include the method system of example 24, wherein the trusted storage includes at least one of firmware storage, a trusted platform module (TPM), or a secure element, configured to store the firmware; and wherein the protected non-volatile storage is protected by an authenticated write access mechanism, and the protected non-volatile storage is further configured to store authenticated variables for the firmware.

Example 26 may include the subject matter of any one of examples 24 to 25, wherein the non-volatile storage includes a partition on a disk storage device, the partition being accessible to the firmware during the boot phase and accessible to an operating system during a runtime phase.

Example 27 may include the subject matter of example 26, wherein the partition is an extensible firmware interface, EFI, or a unified EFI (UEFI) system partition.

Example 28 may include the subject matter of any one of examples 24 to 27, wherein executing the firmware includes extracting a version identifier from the payload and store the version identifier in the protected non-volatile storage together with the first cryptographic hash value as the anchor value.

Example 29 may include the subject matter of any one of examples 24 to 28, wherein executing the firmware includes determining whether an anchor value is present in the protected non-volatile storage before verifying the digital signature, and the method includes using the anchor value to validate the payload.

Example 30 may include the subject matter of example 29, wherein executing the firmware includes, during a subsequent boot phase: computing a third cryptographic hash value of the payload in the non-volatile storage; comparing the third cryptographic hash value with the first cryptographic hash value stored in the protected non-volatile storage; and upon a match, accepting the payload without verifying the digital signature.

Example 31 may include the subject matter of example 30, wherein executing the firmware includes, upon a mismatch between the third cryptographic hash value and the first cryptographic hash value: verifying the digital signature of the payload; upon successful verification, computing an updated cryptographic hash value of the payload; and replacing the first cryptographic hash value stored as the anchor value in the protected non-volatile storage with the updated cryptographic hash value.

Example 32 may include the subject matter of any one of examples 24 to 31, wherein the payload includes platform configuration data, and wherein the method includes, upon successful validation, applying the platform configuration data to configure a function of the computing system during the boot phase.

Example 33 may include the subject matter of any one of examples 24 to 32, wherein the payload includes an executable firmware module.

Example 34 may include the subject matter of example 33, wherein executing the firmware includes loading and executing the executable firmware module during the boot phase upon successful validation.

Example 35 may include the subject matter of example 34, may further include invoking a boot services image loading interface and a boot services image execution interface to load and execute the executable firmware module.

Example 36 may include the subject matter of any one of examples 24 to 35, wherein the access request is received from a runtime software component being executed by the processor after the boot phase, and wherein the runtime software component reads the anchor value from the protected non-volatile storage via a runtime variable access interface, preferably wherein the anchor value is read via a runtime access interface including at least one of a UEFI variable access interface, an ACPI method, or a firmware-to-operating-system communication interface, and preferably wherein the runtime software component is configured to validate the payload.

Example 37 may include the subject matter of any one of examples 24 to 35, wherein the access request is received from the firmware during the boot phase.

Example 38 may include the subject matter of any one of examples 24 to 37, wherein the first cryptographic hash value is stored in the protected non-volatile storage together with a hash algorithm identifier.

Example 39 may include the subject matter of example 38, may further include storing a reference cryptographic hash value computed using a hash algorithm different from that identified by the hash algorithm identifier.

Example 40 may include the subject matter of any one of examples 24 to 39, wherein the first cryptographic hash value is stored in the protected non-volatile storage together with a key identifier identifying the cryptographic key used to verify the digital signature.

Example 41 may include the subject matter of any one of examples 24 to 40, further includes storing a location identifier associated with the payload in the non-volatile storage.

Example 42 may include the subject matter of any one of examples 24 to 41, wherein the first cryptographic hash value is stored in the protected non-volatile storage together with a timestamp.

Example 43 may include the subject matter of any one of examples 24 to 42, wherein the non-volatile storage stores the payload as a file including a header, a data section, and a signature section, and wherein the first cryptographic hash value is computed over the header and the data section.

Example 44 may include the subject matter of any one of examples 24 to 43, may further include storing, in the non-volatile storage, a plurality of payloads, each associated with a respective digital signature, and wherein the protected non-volatile storage is configured to store a respective cryptographic hash value for each of the plurality of payloads.

Example 45 may include the subject matter of any one of examples 24 to 44, may further include updating the anchor value in the protected non-volatile storage in response to an authenticated update request received from an operating system process, wherein the operating system process separately writes a replacement payload and a replacement digital signature to the non-volatile storage, and the authenticated update request to the protected non-volatile storage includes a computed cryptographic hash value of the replacement payload and optionally updated associated metadata.

Example 46 may include the subject matter of any one of examples 24 to 35, wherein a replacement payload and a replacement digital signature are deployed to the non-volatile storage by an operating system process, and wherein executing the firmware includes verifying the replacement digital signature and update the first cryptographic hash value in the protected non-volatile storage during a subsequent boot phase, wherein preferably executing the firmware includes, upon a mismatch between a cryptographic hash value computed over the replacement payload and the first cryptographic hash value included by the anchor value, performing the verification and update.

Example 47 may include a non-transitory computer-readable medium including instructions which, if executed by a processor of a computing system, cause the processor to perform the method of any one of examples 24 to 46.

Example 48 may include an apparatus including means to perform the method of any one of examples 24 to 46.

What is claimed is:

1. A computing system comprising:
a non-volatile storage configured to store a payload and a digital signature of the payload;
a protected non-volatile storage;
a trusted storage configured to store a cryptographic key;
a processor configured to:
execute a firmware during a boot phase, wherein the firmware is configured to cause the processor to:
verify the digital signature using the cryptographic key stored in the trusted storage of the computing system;
compute a first cryptographic hash value of the payload upon successful verification of the digital signature; and
store the first cryptographic hash value as an anchor value in the protected non-volatile storage,
wherein the processor is further configured to validate, in response to a received access request to the payload, the payload by comparing a second cryptographic hash value, computed from the payload in the non-volatile storage, with the first cryptographic hash value stored in the protected non-volatile storage.

2. The computing system of claim 1, wherein the trusted storage comprises at least one of firmware storage, a trusted platform module (TPM), or a secure element, configured to store the firmware; and wherein the protected non-volatile storage is protected by an authenticated write access mechanism, and the protected non-volatile storage is further configured to store authenticated variables for the firmware.

3. The computing system of claim 1, wherein the non-volatile storage comprises a partition on a disk storage device, the partition being accessible to the firmware during the boot phase and accessible to an operating system during a runtime phase.

4. The computing system of claim 3, wherein the partition is an extensible firmware interface, EFI, or a unified EFI (UEFI) system partition.

5. The computing system of claim 1, wherein the firmware is configured to cause the processor to extract a version identifier from the payload and store the version identifier in the protected non-volatile storage together with the first cryptographic hash value as the anchor value.

6. The computing system of claim 1, wherein the firmware is configured to cause the processor to determine whether an anchor value is present in the protected non-volatile storage before verifying the digital signature, and wherein the processor is further configured to use the anchor value to validate the payload.

7. The computing system of claim 6, wherein the firmware is configured to cause the processor to, during a subsequent boot phase:
compute a third cryptographic hash value of the payload in the non-volatile storage;
compare the third cryptographic hash value with the first cryptographic hash value stored in the protected non-volatile storage; and
upon a match, accept the payload without verifying the digital signature.

8. The computing system of claim 7, wherein the firmware is configured to cause the processor to, upon a mismatch between the third cryptographic hash value and the first cryptographic hash value:
verify the digital signature of the payload;
upon successful verification, compute an updated cryptographic hash value of the payload; and
replace the first cryptographic hash value stored as the anchor value in the protected non-volatile storage with the updated cryptographic hash value.

9. The computing system of claim 1, wherein the payload comprises platform configuration data, and wherein the processor is configured to, upon successful validation, apply the platform configuration data to configure a function of the computing system during the boot phase.

10. The computing system of claim 1, wherein the payload comprises an executable firmware module.

11. The computing system of claim 10, wherein the firmware is configured to cause the processor to load and execute the executable firmware module during the boot phase upon successful validation.

12. The computing system of claim 1, wherein the access request is received from a runtime software component being executed by the processor after the boot phase, and wherein the runtime software component reads the anchor value from the protected non-volatile storage via a runtime variable access interface.

13. The computing system of claim 1, wherein the access request is received from the firmware during the boot phase.

14. The computing system of claim 1, wherein the first cryptographic hash value is stored in the protected non-volatile storage together with a key identifier identifying the cryptographic key used to verify the digital signature.

15. The computing system of claim 1, wherein the protected non-volatile storage is further configured to store a location identifier associated with the payload in the non-volatile storage.

16. The computing system of claim 1, wherein the first cryptographic hash value is stored in the protected non-volatile storage together with a timestamp.

17. The computing system of claim 1, wherein the non-volatile storage stores the payload as a file comprising a header, a data section, and a signature section, and wherein the first cryptographic hash value is computed over the header and the data section.

18. The computing system of claim 1, wherein the non-volatile storage is configured to store a plurality of payloads, each associated with a respective digital signature, and wherein the protected non-volatile storage is configured to store a respective cryptographic hash value for each of the plurality of payloads.

19. A method comprising:
executing a firmware during a boot phase, wherein the execution of the firmware comprises:
verifying a digital signature using a cryptographic key stored in a trusted storage of a computing system;
computing a first cryptographic hash value of a payload stored in a non-volatile storage upon successful verification of the digital signature; and
storing the first cryptographic hash value as an anchor value in a protected non-volatile storage,
wherein the method further comprises validating, in response to a received access request to the payload, the payload by comparing a second cryptographic hash value, computed from the payload in the non-volatile storage, with the first cryptographic hash value stored in the protected non-volatile storage.

20. The method of claim 19, wherein the trusted storage comprises at least one of firmware storage, a trusted platform module (TPM), or a secure element, configured to store the firmware; and wherein the protected non-volatile storage is protected by an authenticated write access mechanism, and the protected non-volatile storage is further configured to store authenticated variables for the firmware.
